(19) United States
(12) Patent Application Publication
(10) Pub. No.: US 2003/0035406 A1
(43) Pub. Date: Feb. 20, 2003

(54) Multiple handset wireless conferencing system

(75) Inventors: Ronald H. Fraser, Morgan Hill, CA (US); Raymond R. Shook, Morgan Hill, CA (US)

Correspondence Address: Philip W. Woo, 28th Floor, Three Embarcadero Center, San Francisco, CA, 94111, US

(73) Assignee: PCTEL, Inc.

(21) Appl. No.: 10/194,115

(22) Filed: Jul. 11, 2002

Related U.S. Application Data
(62) Division of application No. 09/054,126, filed on Apr. 2, 1998.

(51) Int. Cl. H04B 7/212

(52) U.S. Cl. 370/347

(57) ABSTRACT

A system is provided for enabling a plurality of wireless communication transceivers to communicate. The system includes at least three wireless communication transceivers operable to communicate using a time division multiple access (TDMA) protocol. The at least three wireless communication transceivers are operable to alternatively serve as a master device according to a predetermined scheme to establish time slots for each of the transceivers, thereby enabling the at least three wireless communication transceivers to communicate in a conference-like manner and without a base station.

### BACKGROUND

1. Field of Invention

This invention relates to the field of wireless communications, specifically to multiple wireless handset time division multiple access (TDMA) conferencing communications.

2. Prior Art

Radios of the past have broadcasted their signals from one user to another user or to a group of users. Two-way communications were established between two entities by taking turns talking and by using a push-to-talk button. Group conversations could not be conducted without some order of taking turns. Conferencing (simultaneous conversation) has only been possible when a base station radio device has been employed to automatically control or connect the parties in a way that all parties can speak and be heard simultaneously. Mobility of the radios in the group and therefore the mobility of the users was restricted to staying in range of the base station.

Cellular telephone companies use TDMA to allow many individuals to communicate digitized voice information to a central station. This usually requires one of the time slots in the TDMA system to be used for overhead to communicate to each radio transceiver which time slot each radio will use for voice communication. These systems also use a separate transmit and receive channel. Communication between users must go through the central location.

Previously, devices such as cordless telephones have restricted the operation of the portable handset to being within range of the base station (a telephone base unit that is connected to the wired telephone line). In cases where a cordless telephone system included more than one handset, the handsets could not communicate with each other without communicating through the base station. This severely limited the use of the radio handsets. The handsets communicate with each other or conference as a group without the base station because the base station is used to control the communication link. In some systems, the base station can give control to a handset to create a handset-to-handset communication link. This same problem of requiring the use of a central control or base station exists with other radio communications systems and appliances.

### SUMMARY OF THE INVENTION

The invention enables a group of radios to communicate in a conference-like manner without having to take turns using a push-to-talk button or being in the presence of a base station. For example, handsets for cordless telephones can now be used as personal radios to communicate with other handsets associated with the same cordless telephone system. This allows these handsets to be used away from the base station located at the home or office.

### OBJECTS AND ADVANTAGES

It is a principal object of the present invention to provide a radio communication system that will allow several users to communicate over radio links in a full duplex conferencing-type system without using a base unit, and each user can take the radio anywhere and communicate in a conference-like manner to one or more other users who are in range.

It is another principal object of the present invention to provide a radio communication system that will allow several independent conferencing groups to operate simultaneously. Individual users can switch between different conferencing groups.

It is another principal object of the present invention to provide a conferencing system where voice data and other types of data can be transmitted to and from transceivers in a communication link. Simultaneous voice/analog and digital data can coexist within a communication link.

In an application where the present invention is implemented in a cordless telephone, handsets for a cordless telephone system can now be used as personal radios to communicate with other handsets associated with the same cordless telephone system. This allows handsets to be used away from the base station located at the home or office. Each handset can be part of a conference call using the base station to connect the communication link to a telephone line. The transceiver portion of the telephone base unit functions in the same manner as a handset. In the case of a cordless telephone system that has more than one telephone line, the base unit transceiver can simultaneously communicate with handsets conducting a normal telephone call over one telephone line and process digital information from other handsets over a different line.

A communication system has been described which features one embodiment of the invention. It is to be understood, however, that the scope of the invention is not limited to such a system or to the specific frequencies, circuit designs, values, parameters, etc. suggested, but only by the scope of the following claims. Various other embodiments and modifications thereof will become apparent to persons skilled in the art, and will fall within the scope of invention as defined in the following claims.

### BRIEF DESCRIPTION OF THE DRAWINGS

FIG. 1 is a block diagram of the preferred embodiment for a TDMA wireless conferencing system;

FIG. 2 is a block diagram of the electronics in the preferred embodiment;

FIG. 3 is a schematic of a power supply, reset circuit and data discriminator;

FIG. 4 is a schematic of a field programmable gate array (FPGA);

FIG. 5 is a schematic of a microcontroller and an electrically erasable programmable read only memory (EEPROM);

FIG. 6 is a schematic of coders/decoders (codecs) and how their analog outputs are connected together through filters;

FIG. 7 is a schematic of a fourth codec which is connected to the codecs in FIG. 6 through a filter. It also shows how the microphone and speaker are connected through amplifiers to the codecs;

FIG. 8 is a schematic of a portion of the FPGA which is used for loading parameters;

FIG. 9 is a block diagram of four shift register systems used in the FPGA;

FIG. 10 is a block diagram of an audio clock generator and an output shift register system used in the FPGA;

FIG. 11 is a schematic of each of the shift register systems in FIG. 9;

FIG. 12 is a schematic of the output shift register system in FIG. 10;

FIG. 13 is a schematic of a portion of the audio clock generator system in FIG. 10

FIG. 14 is a schematic of another portion of the audio clock generator system in FIG. 10;

FIG. 15 is a block diagram of an input shift register system and of an output shift register system used for radio data and found in the FPGA;

FIG. 16 is a schematic of the output shift register system in FIG. 10;

FIG. 17 is a schematic of the clocking system used for the output shift register system in FIG. 10;

FIG. 18 is a schematic of the input shift register system in FIG. 10;

FIG. 19 is a block diagram of a clock recovery system and start byte detect system used for the received radio data and found in the FPGA;

FIG. 20 is a schematic of the TIMER section of FIG. 19;

FIG. 22 is a schematic of another part of the clock recovery circuit in FIG. 19;

FIG. 23 is a schematic of a part of a six register up/down counter found in FIG. 21;

FIG. 24 is a schematic of another part of a six register up/down counter found in FIG. 21;

FIG. 25 is a schematic of part of a digital phase lock loop found in FIG. 19;

FIG. 26 is a schematic of part of a digital phase lock loop found in FIG. 19;

FIG. 27 is a schematic of part of a digital phase lock loop found in FIG. 19;

FIG. 28 is a schematic of digital filtering and data recovery circuits found in FIG. 19;

FIG. 29 is a schematic of part of a start word detect circuit found in FIG. 19;

FIG. 30 is a schematic of part of a start word detect circuit found in FIG. 19;

FIG. 31 is a schematic of part of a start word detect circuit found in FIG. 19;

FIG. 32 is a schematic of a latch system found in FIG. 31

FIG. 33 is a schematic of part of a start word detect circuit found in FIG. 19;

FIG. 34 is a block diagram and schematic of a bus driver and tri-state interface to a microcontroller port or bus;

FIG. 35 is a schematic of a block found in FIG. 34;

FIG. 36 is a block diagram of a multiple handset cordless telephone with a wireless conferencing system and handset that can work independently of a base station;

FIG. 37 is a block diagram of the base station electronics used for the basic cordless telephone system of FIG. 36; and

FIG. 38 is a block diagram of the electronics used in a two telephone line interface for FIG. 37.

### DETAILED DESCRIPTION

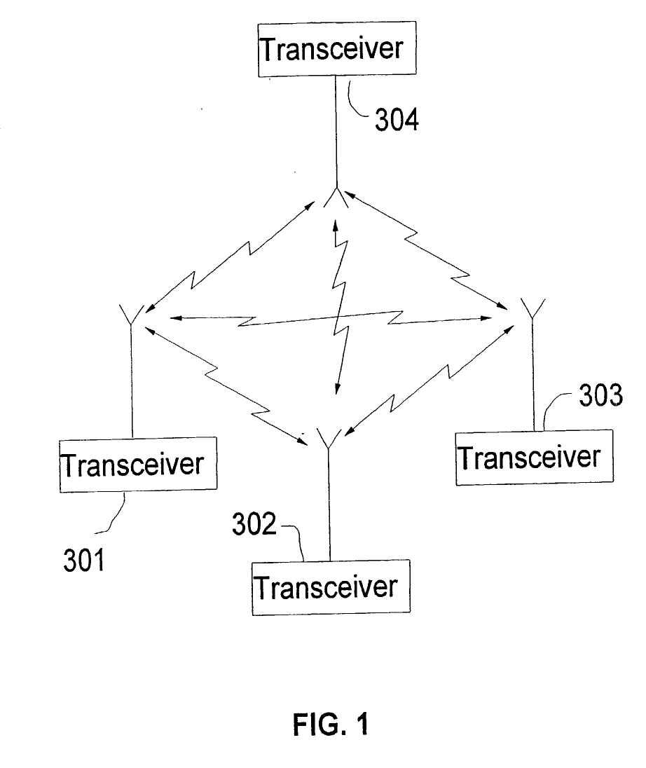

A block diagram of the preferred embodiment is shown in FIG. 1. In the preferred embodiment, all communication transceivers 301, 302, 303, and 304 are frequency hopping spread spectrum type radio receivers. In the frequency hopping transmission timing, each channel hop takes less than 200 microseconds. When a transceiver turns on, it first goes into a search-for-master mode to see if another transceiver is acting as a master transceiver looking for transceivers to add in as slaves. The transceiver stays in the search-for-master mode for a specified period of time. If it sees no other transceivers acting as a master transceiver, it becomes a master transceiver. As a master transceiver, the transceiver sends an information packet telling other transceivers it is a master transceiver looking for slaves to come on line. When a master transceiver is looking for slaves to add in to slave time slots, it is in master mode.

The transmission sequence consists of sending a string of repeating zeros and ones that represent the clock rate of the data for 500 microseconds, sending the start word and then sending the data packet. An information packet includes the clock recovery bits, the start word and the data packet. If clock recovery is not needed, the information packet includes all of the above except the clock recovery bits. The data packet includes a group number and command that tells the other transceivers which time slot to add into. The command byte can be used for sending acknowledge-type signals, bad RF channel information, pushed button information, etc. A string of data bytes consisting of various kinds of digital data is also included in the data packet. The various kinds of data include modem data, digitized voice, caller-identification data, video data, etc.

Addresses can be used instead of group numbers in other embodiments. When addresses are used instead of group numbers, all the addresses of transceivers that can communicate in a conference-like manner have to be held in a buffer.

In the preferred embodiment, four equal length time slots are used. In other embodiments, unequal length time slots can be used and the number of time slots can be more or less than four. If, after a certain length of time, the master transceiver does not find any slaves to add into one of the time slots, the master goes back into the search-for-master mode to wait for another device to come on and act as a master. In the preferred embodiment, the amount of time each individual transceiver acts as a master looking for slaves is different. Therefore, no two transceivers will remain in a master mode or a search-for-master mode at the same time. In alternative embodiments, the search-for-master mode timing can vary between transmitters or both search-for-master mode and master mode timings can vary. It should be noted that there are a certain number of reasonable variations in the timing so that no two transceivers will have the exact same timing. This problem can be solved by programming the units with this variable timing to make sure that no two are the same within the same system. In the preferred embodiment, the length of time waiting in the master mode is varied according to the address.

After a master transceiver sends its data packet in slot 1, it listens for another unit to request to be added in during slots 2, 3, and 4. Included in the master data packet is a command requesting a slave unit to occupy a particular empty time slot if one is available. When a transceiver that is in search-for-master mode, receives the request to add into a particular time slot from the master, it transmits a data packet back to the other transceivers requesting the master to add it into the open time slot. This transmission occurs during the open time slot. Requests are acknowledged only from units having the same group number. The command in the data packet of the slave transceiver tells the master which slot it wants to add into and tells the master that the data bytes hold the unit address of the transceiver making the request. In other embodiments, the command byte can be used to tell the other transceivers what kind of data is contained in the data packet such as caller-identification data or modem-type data. Since each transceiver holds a unit address, the master can send an acknowledgment command back to each transceiver with the unit address of the unit it is responding to (again in the data bytes). This will eliminate two transceivers trying to add to the same time slot. Once a slave is added into a time slot, it can now receive voice or other data from the other transceivers. In other embodiments, the group number can be eliminated and the address can be used to determine if a slave is to be added into a time slot. Each transceiver is allocated a particular time slot in which to operate. If all the time slots are being used, the master transceiver sends a different command so that other slave transceivers are not requested to add into a time slot. In the preferred embodiment, other slave transceivers go into a receive-only mode where information is received from all the transceivers that occupy time slots.

In other embodiments, slave units can be set up that have no capability to transmit and therefore cannot become master transceivers but can receive the information sent by the master transceiver and other slave transceivers.

In other embodiments, the master transceiver can keep certain transceivers from having access to an open slot or receiving and using the information because each transceiver has its own address. By keeping a list of addresses in a buffer that is to be blocked from joining a communication link, a master transceiver can block specific transceivers from getting an open time slot. The master transceiver can also have private communications with one or more other transceivers by only allowing transceivers with specific addresses to add into open time slots or listen to the communication link.

Transceiver 301 sends a data packet to transceivers 302, 303, and 304 in the communication link. Transceivers 302, 303, and 304 all receive the data packet in the communication link. Assuming transceiver 301 is the master, transceiver 302 is in slot 2, transceiver 303 is in slot 3, and transceiver 304 is in slot 4, then transceiver 302 would begin its transmission sequence right after receiving the last byte of the data packet of transceiver 301. Transmitter 303 would begin its transmission sequence right after receiving the last byte of the data packet of transceiver 302. Transceiver 304 would begin its transmission sequence right after receiving the last byte of the data packet of transceiver 303. When a time slot has no transceiver sending information, the transceivers use timers to estimate the timing that would have been used by a transceiver to transmit its information. This allows all the transceivers to stay in synchronization even though a slot is not being used.

In the preferred embodiment, two different timers are used. The first timer tells the transceiver that it should have received a start word before the timer times out. If a start word is detected, this timer is disabled. If a start word is not detected, a second timer is started when the first timer times out and the receive buffer is filled with a data sequence that creates a constant voltage out of the appropriate decoder. The second timer times out when the next time slot is ready to be received and the first timer is started again. If a good packet of data is received, the first timer is started at the end of receiving a good data packet unless it is time to transmit the data buffer over the communication link to the other transceivers. At the end of transmitting a data buffer, the first timer is started again.

In other embodiments, instead of two timers, one timer could be used for each time slot duration and/or a timer for the next time to start transmission sequence could be used to keep all the units in synchronization.

Also in alternative embodiments, the timers may be of different duration depending on the time slot being received or the type of device sending the information.

All data packets are received from every transceiver so that all audio information from the other three transceivers can be summed and put to the speaker at each unit.

A transceiver going out of range of another transceiver causes errors in the group number, the command byte or the start word. If the start word has too many errors, no data will come through and the data buffer is filled with a data sequence that creates a constant voltage out of the appropriate decoder. If either the group number or the command byte is good, the data bytes are accepted. Both the group number and the command byte must be correct when a transceiver is trying to add into a slot. A master transceiver will drop a slave transceiver from a time slot if it receives too many bad packets in a row. The master transceiver then sends a command to request a transceiver to add into that time slot that was dropped. This tells the transceiver that was dropped that it needs to request to be added in again. A counter is used in microprocessor 307 to determine if too many bad packets have been received. The counter is reset every time a good packet of data is received.

In other embodiments, other error detection techniques can be used. Error detection techniques can be used for the whole data packet instead of just the address and/or the command byte to determine if a bad packet was received. Error correction codes can be used to correct bit errors in data packets if not too many bit errors were received. Using error correction codes can help to reduce bad packets of data and keep transceivers in synchronization.

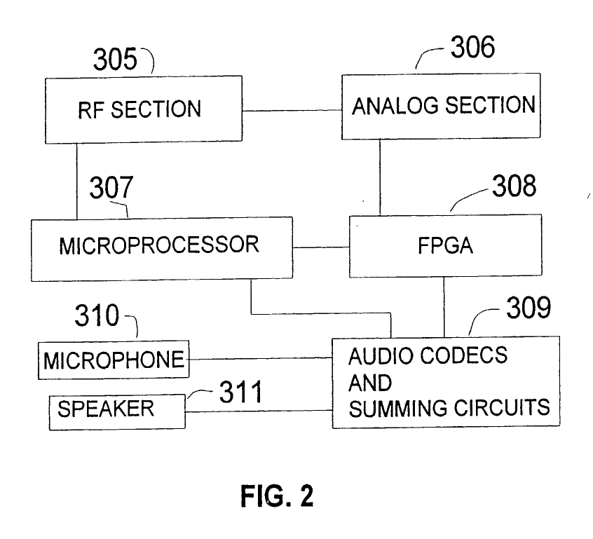

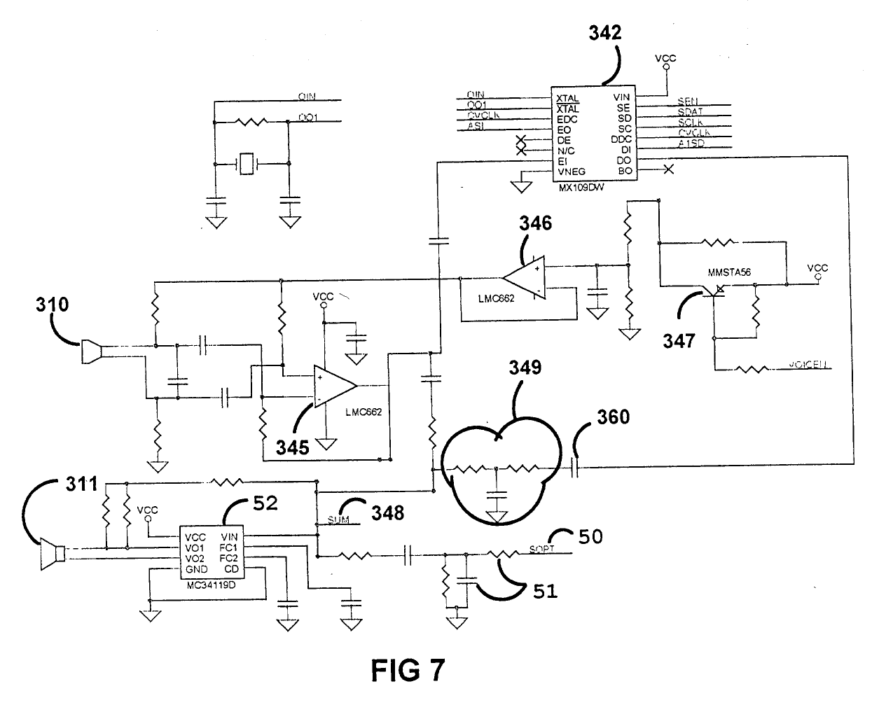

FIG. 2 is a block diagram of the electronics in the communication transceiver preferred embodiment. RF section 305 is a frequency hopping spread spectrum transceiver. The RF section 305 can be termed as a transceiver by itself but for the purpose of this description, the whole of FIG. 2 will be called transceiver or communication transceiver. The output of RF section 305 is the quadrature detected analog signal showing frequency demodulated data. The preferred embodiment uses frequency shift keyed (FSK) data but any form of data modulation could be used with the appropriate demodulation. The quadrature detected signal goes into the analog section 306 where it is digitized and sent to the FPGA 308. The FPGA 308 takes the data in, recovers the clock from the first 500 microseconds of transmission, confirms that the start word is received correctly, tells the microprocessor 307 that data is coming, converts the incoming data stream to a parallel format, and sends one byte of received data at a time to the microprocessor 307. The microprocessor 307 receives the radio data and stores it in appropriate buffers for each time slot. The microprocessor 307 can also be called a microcontroller. The microprocessor 307 also controls the RF section 305, programs the audio codecs 309, FPGA 308, etc. The microprocessor 307 operates timing functions. The microprocessor 307 keeps separate buffers for each transceiver from which it receives data. The audio data received from other transceivers is sent in a parallel form to separate buffers for each audio path in the FPGA 308. The FPGA 308 converts each of the audio data buffers to a serial form, synchronizes the data and sends it to different audio codecs 309 for each audio channel. The audio codecs 309 convert the serial data stream to an analog form which is input into a summing amplifier 52 (show in FIG. 7). This amplifier 52 sends the combined signal to speaker 311. Microphone 310 amplifies voice information and sends it into audio codec 309 which digitizes the audio into a serial data stream that is sent in to FPGA 308. FPGA 308 converts the serial data into a parallel format and sends it to microprocessor 307. Microprocessor 307 stores this information in a transmission buffer. At the appropriate time during the transmission time of a transceiver, microprocessor 307 sends the transmission buffer a byte at a time to FPGA 308. FPGAS 308 converts received parallel data into a serial format and sends it to the RF section 305.

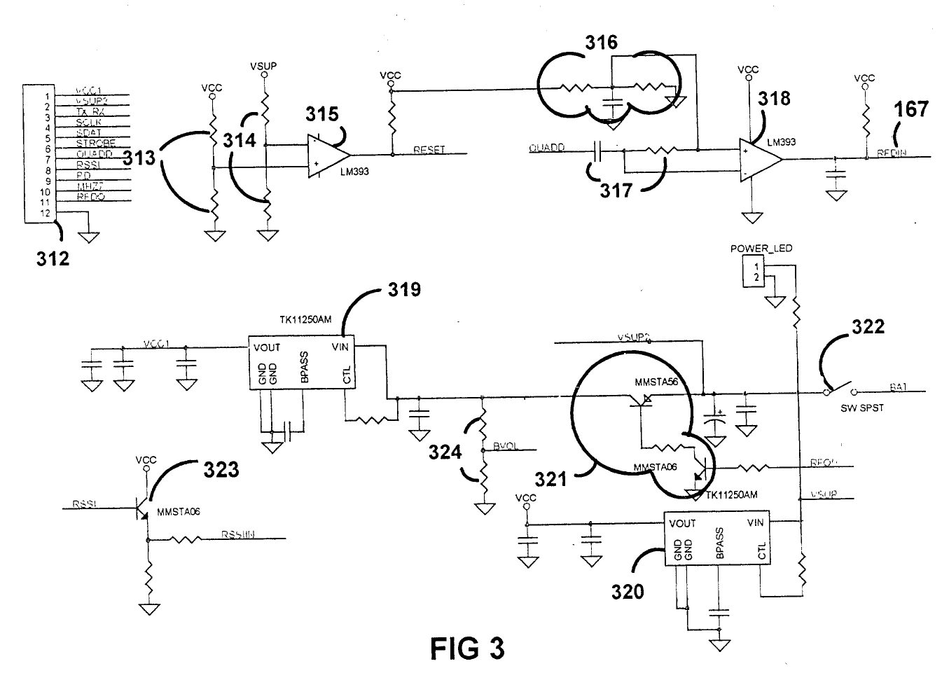

FIG. 3 shows a detailed schematic of the analog section 306 in FIG. 2. It shows the power supply 319 and 320 for the transceiver. Connection 312 goes to the RF section 305. The circuit containing resistor dividers 313 and 314 and comparator 315 is the power-on reset for the transceivers. DC reference 316 creates a comparison point for comparator 318 which is the demodulator for the received quadrature detected data. Filter 317 AC couples the quadrature detected data and filters it before being compared to reference 316. The resulting RF data 167 goes into the FPGA 308. The received signal strength indicator (RSS) is buffered by transistor 323 and then sent to an AND input on microprocessor 307. On/off switch 322 controls the power for the system. The microprocessor 307 can control the power to the RF section 305 through switch 321. This allows the microprocessor 307 to do other functions such as receiving parameters or programming other devices without losing current to the RF section 305. Resistor 324 creates a voltage level that is sent to an A/D input of microprocessor 307 for use as a low battery detector.

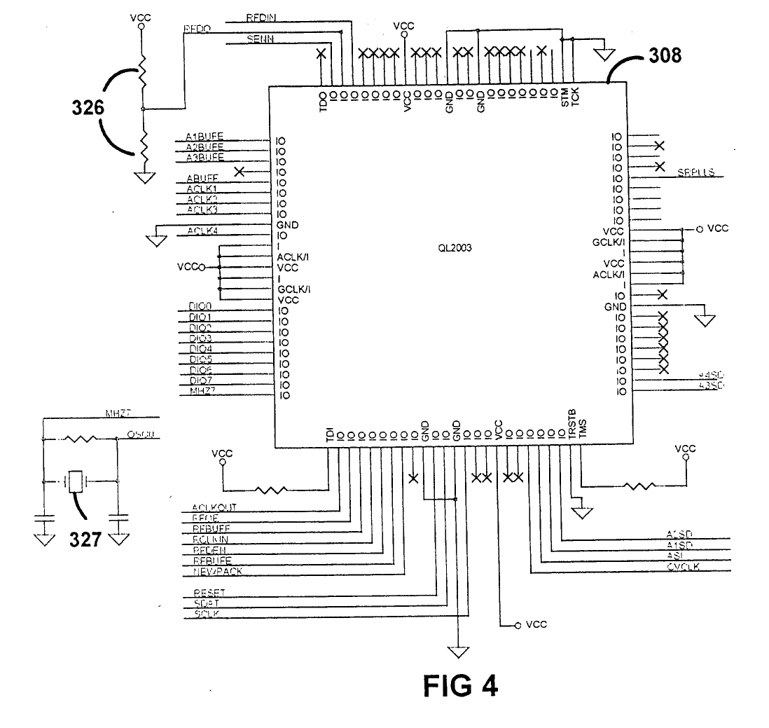

FIG. 4 shows the connections to the FPGA 308. Data is sent through resistors 326 to the RF section 305 where the data is transmitted. Resistors 326 center the voltage when the output from FPGA 308 is in tri-state. Crystal 327 is the crystal for setting the frequency at which the microprocessor 307, the FPGA 308 and the RF section 305 operate.

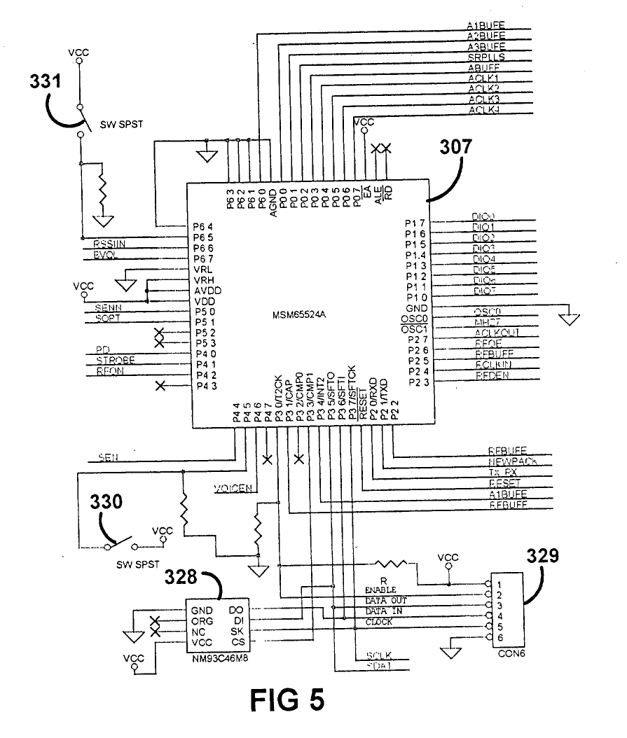

FIG. 5 shows the connections to the microprocessor 307. Switch 331 causes the transceiver to change between two different group numbers. This allows a unit to have more than one group number. A transceiver with more than one group number can be part of different conferencing groups by changing switch 331 which changes the transceiver's group number to a different group number that was stored in memory. Each time the switch 331 changes state, the transceiver goes into a search-for-master mode in order to be added to the appropriate conferencing group with the new group number. In alternative embodiments, a keypad or other means can be used to go between two or more group numbers. Also in alternative embodiments, the group number can be changed to any group number through a keypad interface. Alternate embodiments may also use addresses or parts of addresses instead of group numbers. Switch 330 is used as a push-to-talk function. Even though only four transceivers can transmit at one time in the preferred embodiment, unlimited transceivers can listen to the four transceivers that are transmitting. The preferred embodiment includes the capability of keeping slot 4 open for push-to-talk transceivers which use switch 330 when they want to transmit. Other embodiments can use different time slots with push-to-talk transceivers. Connector 329 is used to program parameters into microprocessor 307 or EEPROM 328. Some microprocessors may have internal EEPROM to eliminate the need for external EEPROM 328.

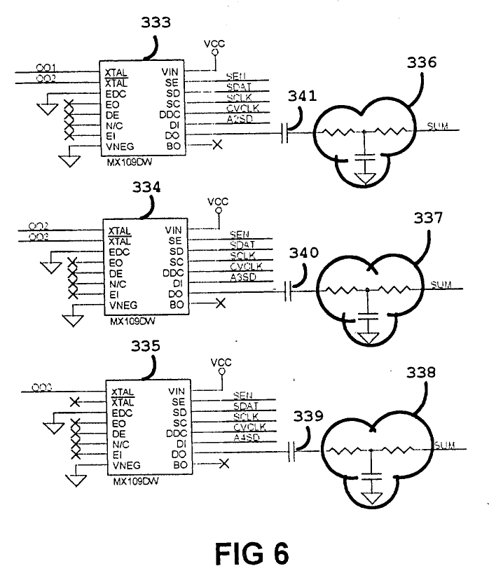

FIG. 6 shows that the preferred embodiment uses continuously variable slope delta (CVSD) modulators/demodulators (codecs) 333, 334, 335, and 342. Other types of codecs or audio compression type chips or techniques can be used. Some of the more advanced compression techniques will help to increase the number of time slots or simultaneous communication paths available to the system without increasing the bandwidth requirements of the RF channels. Capacitors 339, 340, 341 (FIG. 6) and 360 (FIG. 7) are used to block any DC signal from reaching the summing amplifier 52 (FIG. 7). These capacitors can be eliminated if the DC reference used by the codecs 333, 334, 335, and 342 is the same as the reference used by the summing amplifier 52. Filters 336, 337, 338, and 349 filter the analog outputs from the codecs 333, 334, 335, and 342 to get rid of any digital and high frequency noise before going into summing junction 348. Codecs 333, 334, and 335 convert digital data to analog signals. Codec 342 of FIG. 7 converts digital data to analog signals and also converts analog signals from amplifier 345 to digital data. Amplifier 345 is a differential amplifier that receives voice information from microphone 310. A differential amplifier was used in the preferred embodiment because the microphone 310 could be several feet from amplifier 345. A single ended amplifier can be used in most embodiments. Even though the preferred embodiment shows the use of voice information coming into amplifier 345, any form of analog data can be used in other embodiments. Amplifier 346 sends a stable DC reference to amplifier 345 and to power microphone 310. Transistor 347 acts as a switch which is controlled by microprocessor 307. This enables the microprocessor 307 to turn off the reference so that amplifier 345 is essentially turned off. This keeps unwanted noise from this transceiver from interfering with communication between other transceivers in a high noise environment. The microprocessor 307 can also send tonal information to the user by putting a digital wave-form out on SOPT 50. This signal is filtered through filter 51 and sent to the speaker 311. This allows microprocessor 307 to send information to the user such as low battery warnings, busy signals, ring signals, etc. In alternative embodiments, any analog-type signal can be summed with other signals into summing junction 348 allowing the user to receive information such as stored messages from other users, frequency synthesized words, etc.

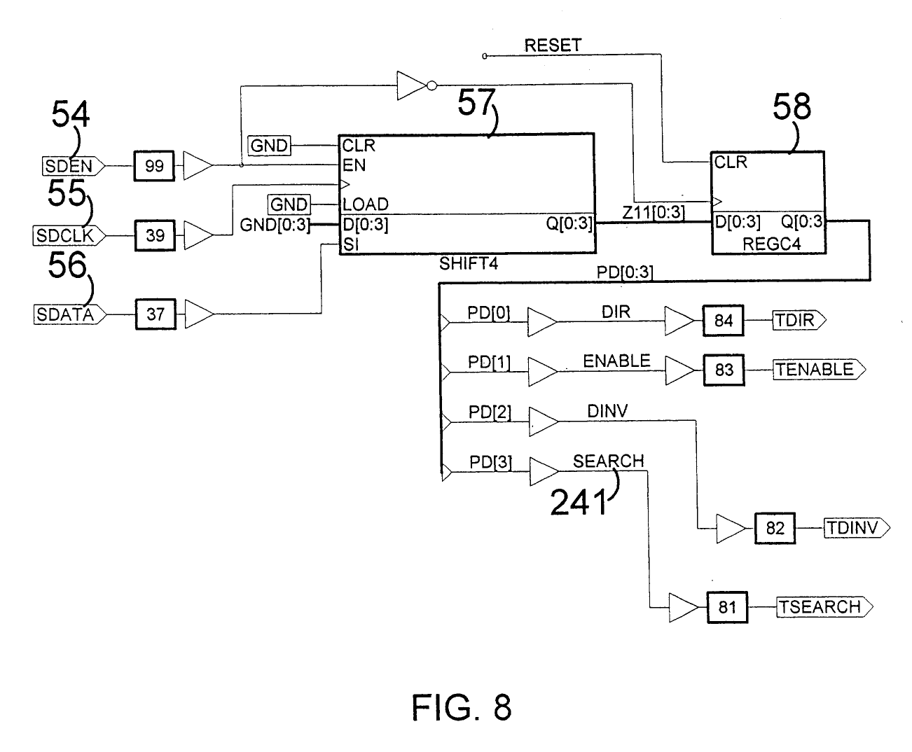

FIGS. 8, 9, 11, 15, 19 and 34 are upper level schematics that show all the functions in FPGA 308 and show information flow inside the FPGA 308. FIG. 8 is a schematic showing how parameters are loaded into the FPGA 308 from microprocessor 307. Programming is enabled by pulling SDEN 54 high while sending dock 55 and data 56 signals into shift register 57. The contents of shift register 57 are latched into register 58 when SDEN 54 is brought low again.

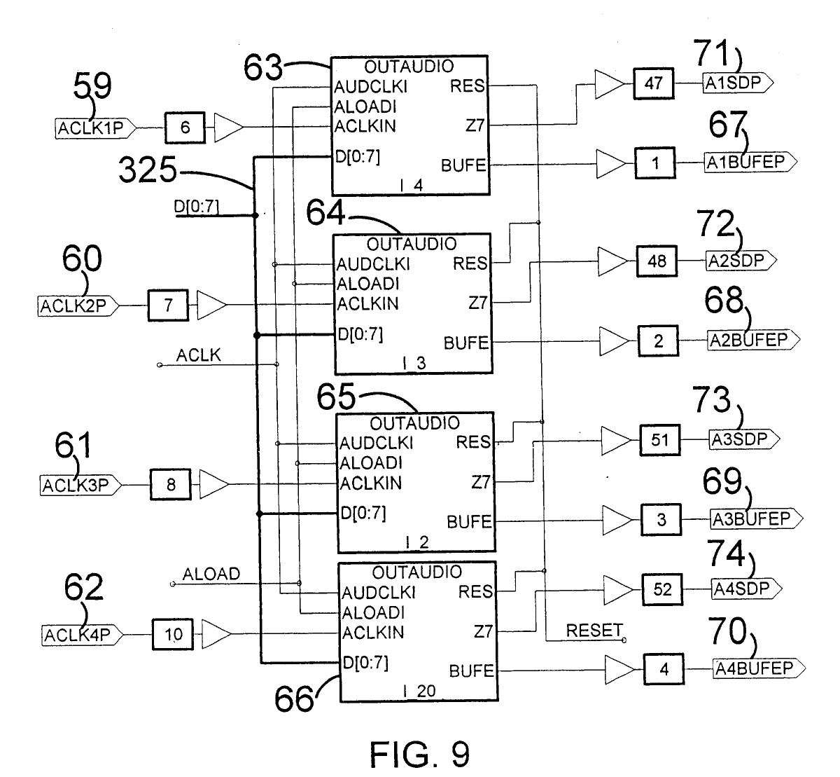

FIG. 9 shows the upper level of how the microprocessor 307 clocks parallel audio data into FPGA 308 by using data bus 325 and clock signals 59, 60, 61, and 62. OUTAUDIO circuits 63, 64, 65, and 66 then convert the parallel audio data to serial data and shift this data to the codecs 333, 334, 335, and 342 on signals 71, 72, 73, and 74. When the audio buffer is ready for more data, it sends a buffer-empty signal 67, 68, 69, and 70 to the microprocessor 307. With these four audio paths, users can listen to four other people talking at the same time. Additional audio circuits identical to circuits 59, 63, 67, and 71 need to be added to support more simultaneous conversations.

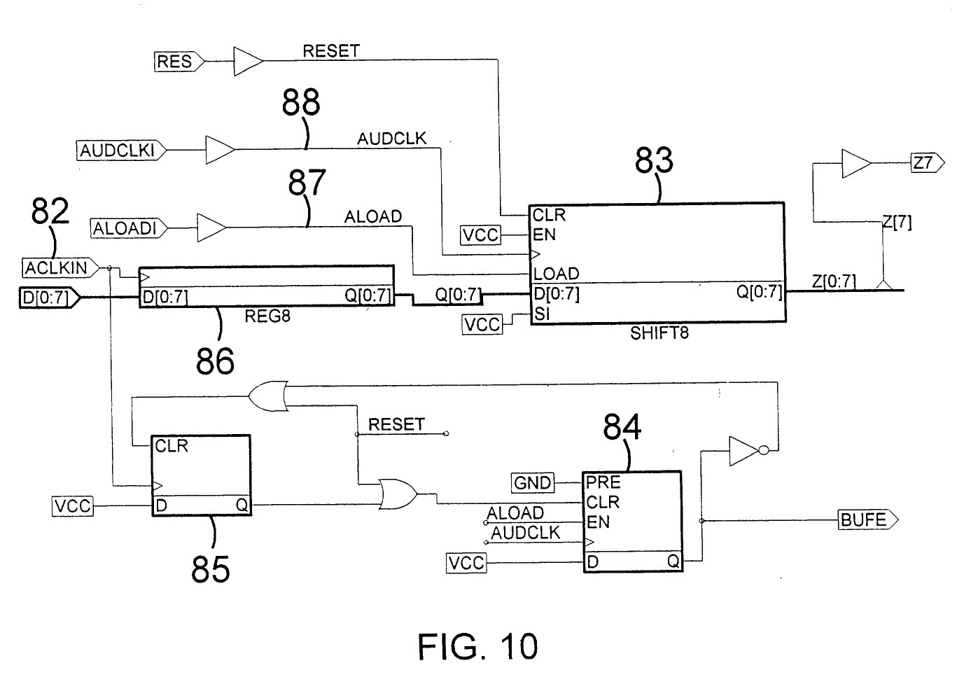

FIG. 10 is a schematic of the circuits inside each OUTAUDIO block 63, 64, 65, and 66. It shows how the data is double buffered. When the circuit sends a buffer-empty signal out of flip flop 84, the microprocessor 307 clocks a new data byte into register 86 with clock 82. ACLKIN 82 triggers flip flop 85 to clear flip flop 84. The data is held in register 86 until shift register 83 shifts out its last bit at which time ALOAD 87 loads the data from register 86 into shift register 83 and triggers flip flop 84 to send the buffer-empty signal. Clock signal 88 controls the data rate for shifting data out of shift register 83.

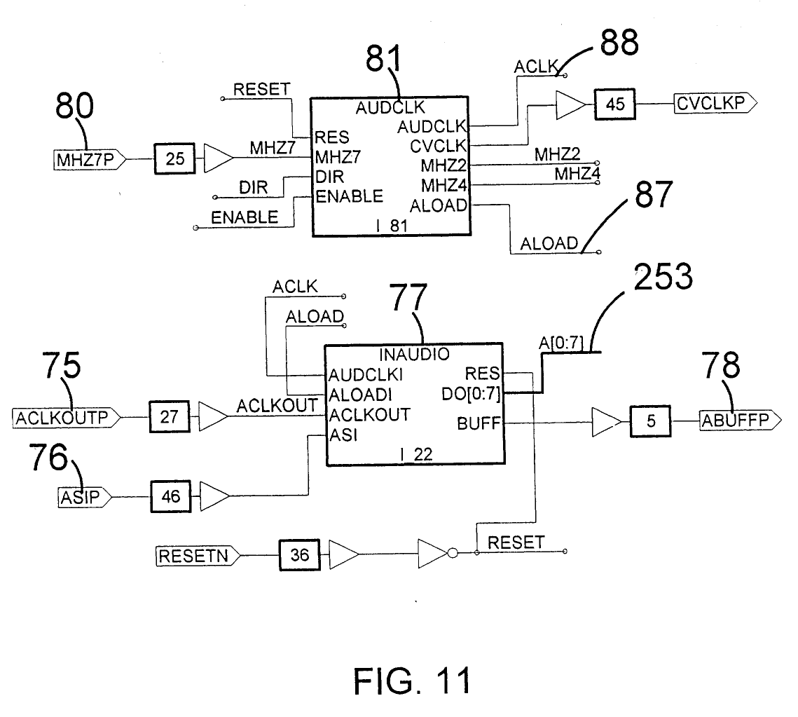

FIG. 11 shows the upper level schematic of INAUDIO 77 which shows how the microprocessor 307 clocks parallel audio data from FPGA 308 by using the signal ACLKOUT 75 to put data onto bus 253. It also shows the upper level schematic of AUDCLK 81 which generates the audio clock signal 88, the audio load signal 87 and other clocking signals for the system. All clock signals start from reference clock MHZ7P 80. INAUDIO 77 receives digitized audio data from the microphone 310 via signal 76 and converts it to parallel form for sending to the microprocessor 307 where it is buffered and finally transmitted to the other users. Each time INAUDIO 77 is ready to send data to the microprocessor 307, it sets signal 78 high.

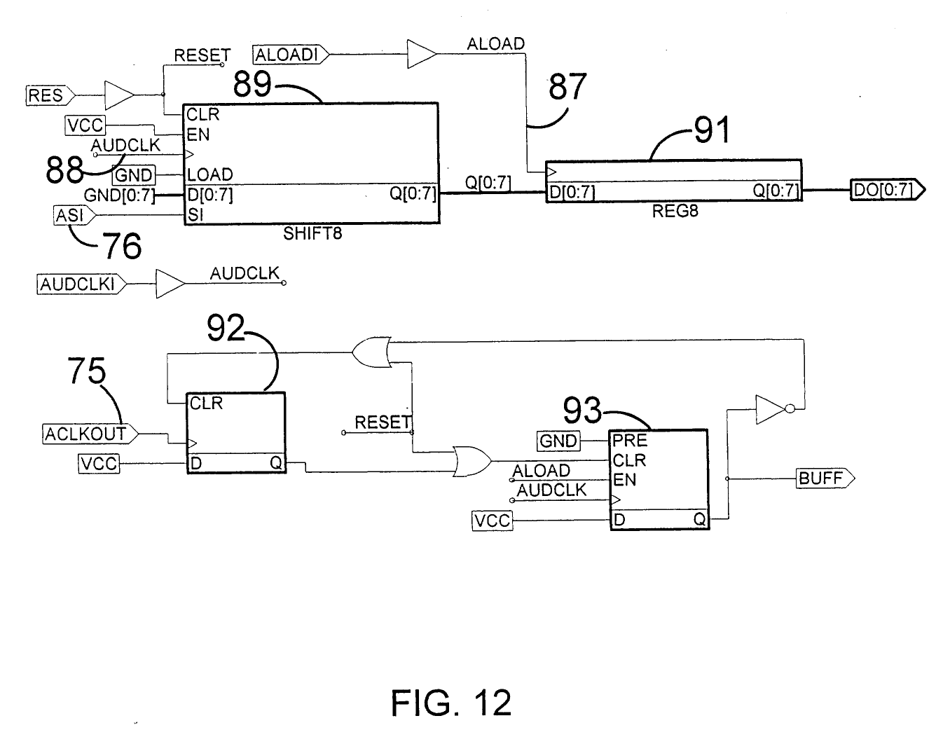

FIG. 12 is a schematic of the circuits inside INAUDIO 77. AUDCLK 88 clocks serial data 76 into shift register 89. When shift register 89 is full, the byte of data is loaded into register 91 by load signal 87 and flip flop 93 is triggered to send a buffer-full signal 78 to the microprocessor 307. After reading the data, the microprocessor 307 clears flip flop 93 by setting flip flop 92 with ACLKOUT 75.

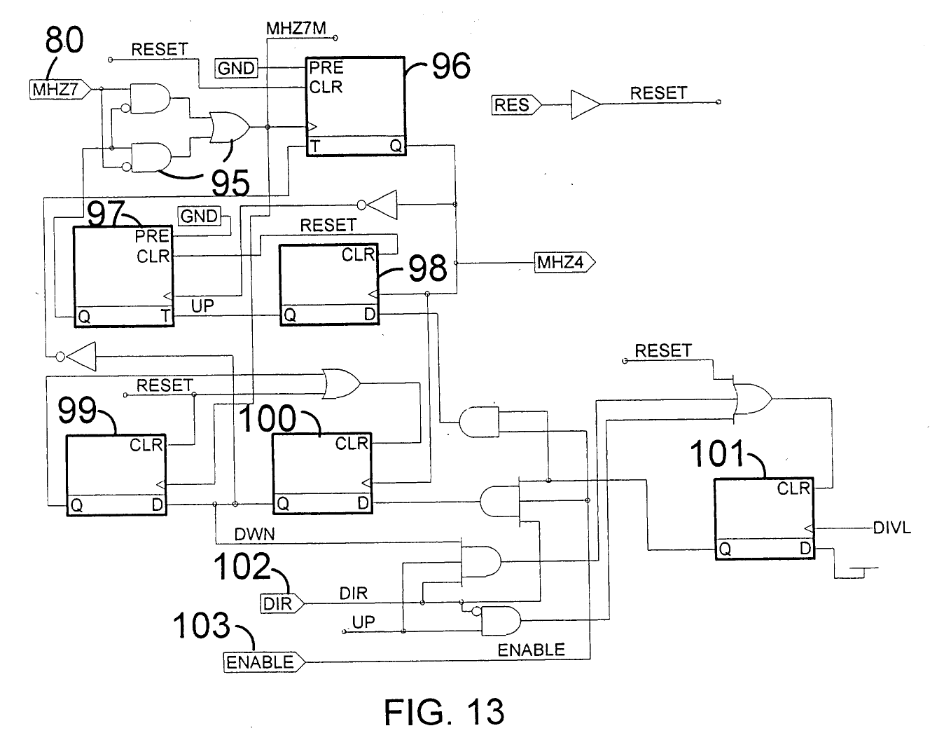

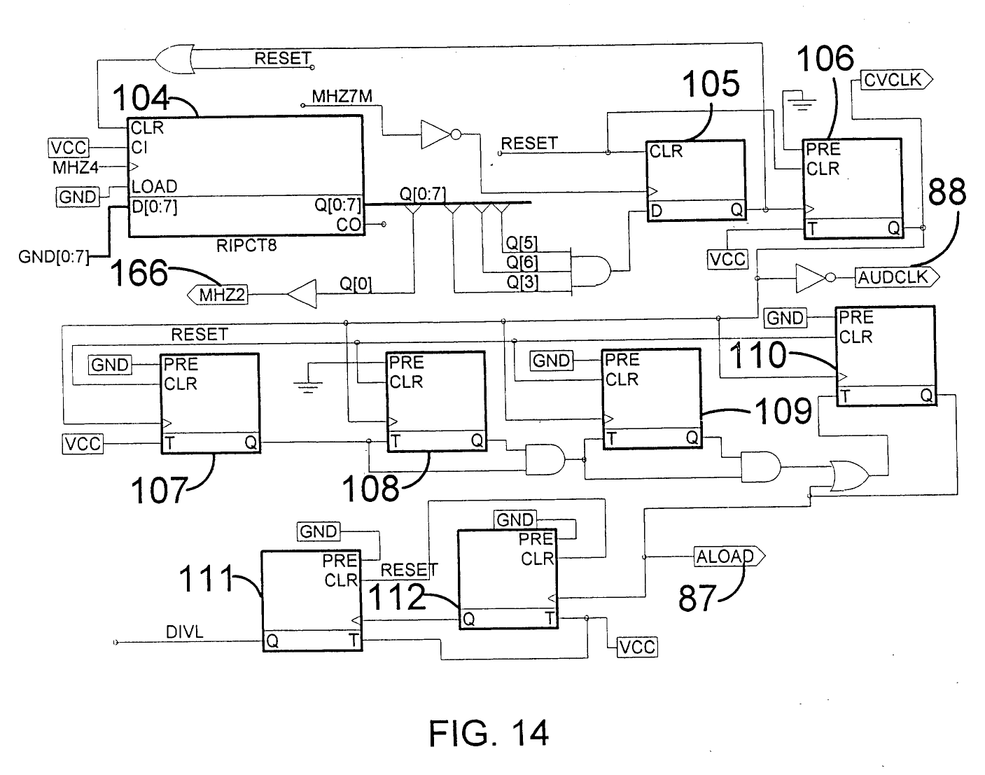

FIGS. 13 and 14 are schematics of the circuits inside AUDCLK 81 of FIG. 11. Counters made up of flip flop 96, ripple counter 104 and flip flops 105 and 106 divide the main crystal frequency 80 to create the audio clock signal 88 and the main clock for shifting data into and out of the audio codecs 333, 334, 335, and 342. Flip flops 107-110 further divide the audio clock signal 88 to create the register load signal ALOAD 87. This circuitry keeps all the audio data shift registers synchronized. All the buffers will shift at the same time and will empty at the same time. This approach eases the load requirements in microprocessor 307.

ALOAD 87 is further divided by flip flops 101, 111, and 112 to create a time base for the speeding up and the slowing down of the AUDCLK 88 signal. With a wireless conferencing system, the complexity of the system is reduced if the time bases of the different transceivers are synchronized. Thus, all audio buffers on all communicating transceivers will empty at the same rate. Since there are inaccuracies in the crystals in each transceiver, a means to keep all the transceivers synchronized is needed. One method is to phase lock the crystal in each of the transceivers by using the recovered clock in one of the data streams as a reference in a phase lock loop. In another method, the crystal or the time base of each transceiver is synchronized to an external time base like the Global Positioning Satellite (GPS) system time base or any common time base that can be received by all the transceivers. An external time base can also be used to keep accurate positioning of the time slots. In the preferred embodiment, the crystals are not phase locked but the speed of the clock that is used to create AUDCLK 88 signal is increased or decreased to match the transmission times of the master transceiver. When the master transceiver starts sending its data packet, each of the slave transceivers will have a pointer to a memory address in the audio buffer for sending information to the speaker. This pointer should always be pointing at the same memory address when the master transceiver starts its transmission. If the pointer is ahead or behind the correct address, the microprocessor 307 will speed up or slow down the audio clock rate. This will simulate phase locking all the crystals of the transceivers.

Microprocessor 307 causes the audio clock speed to change by first sending an enable signal 103 and then sending a direction bit 102 which causes the audio clock to speed up or slow down depending on whether the direction bit 102 is high or low. The signal coming out of flip flop 101 allows flip flop 98 to go high when signal 103 is also high. On the next clock signal out of flip flop 96, flip flop 97 will go high which toggles digital switch 95. Toggling digital switch 95 causes the clock going into flip flop 96 to invert from high to low. This will cause the frequency coming out of flip flop 96 to speed up by one half of a cycle of MHZ7 80 which in turn causes AUDCLK 88 to speed up. If direction bit 102 is high, then the output of flip flop 100 will go high which causes flip flop 96 not to toggle for one of its clock cycles. The effect of this is that the frequency coming out of flip flop 96 slows down by one half of a cycle of MHZ7 80. Flip flop 99 is used for clearing flip flop 100 at the appropriate time.

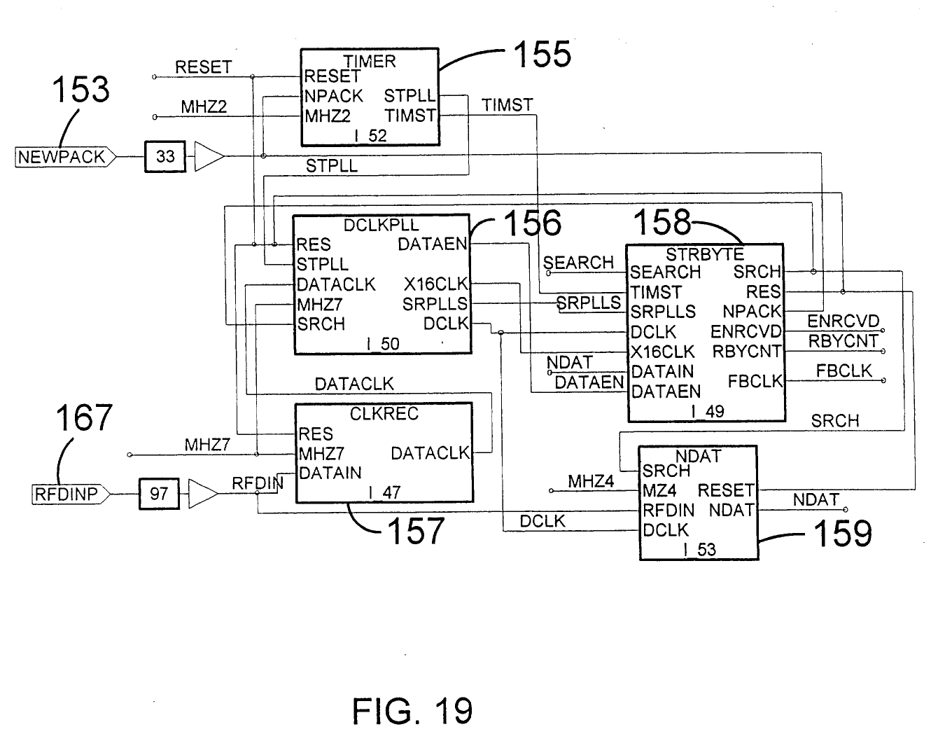

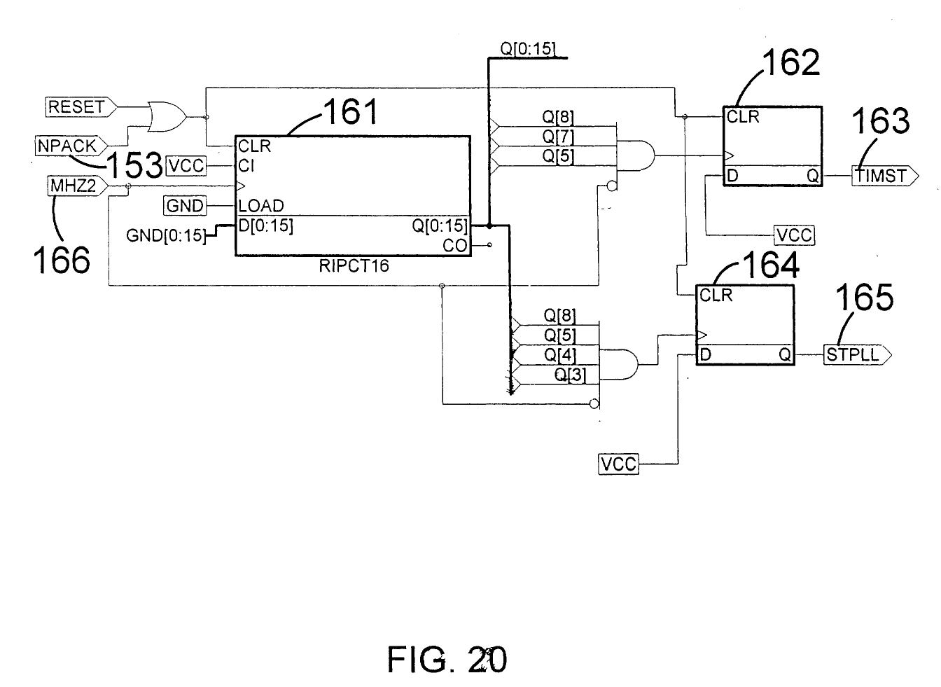

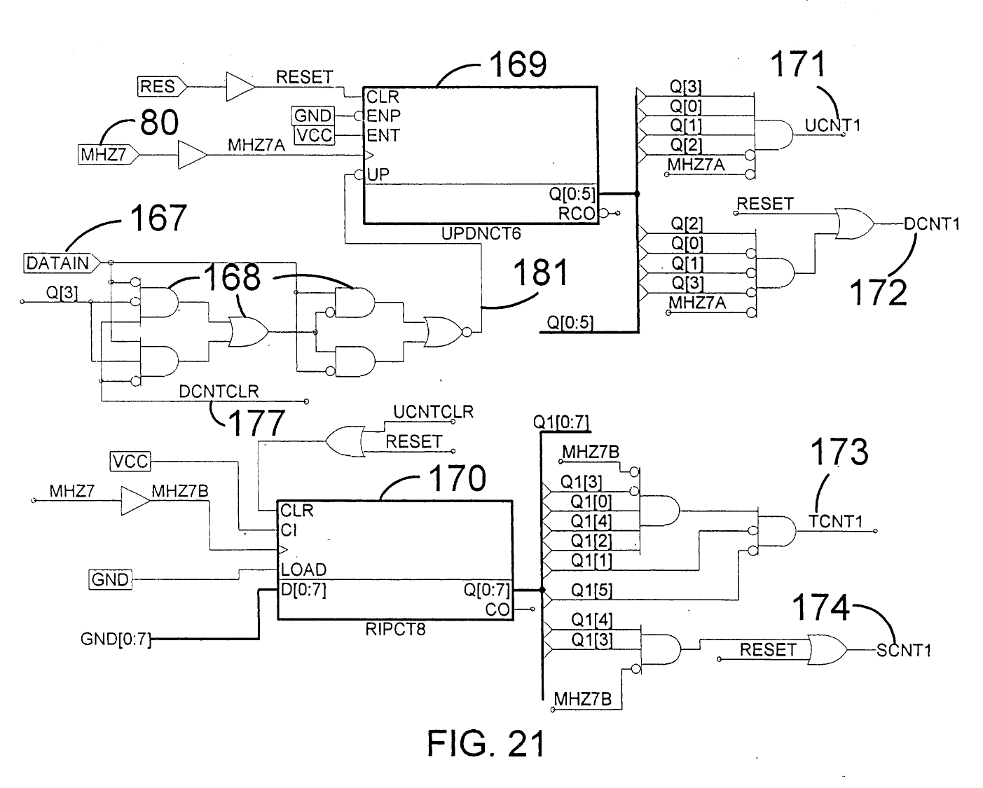

FIG. 19 is the upper level schematic of the clock recovery 157, data clock phase lock loop 156, data recovery 159, start word detect 158, and timer circuits 155 for received RF data 167. When the microprocessor 307 is expecting to receive a new pack of data from another transceiver, it toggles NEWPACK 153 twice to go high then low in order to initialize the circuits of FIG. 19. A new data packet starts with 500 micro seconds of high-low combinations that represents the clock rate of the upcoming data. This data comes in on RFDINP 167 and goes into CLKREC 157. FIG. 20 is a detailed schematic of TIMER 155. The signal NPACK 153 initializes counter 161 and flip flops 162 and 164. A short delay after the beginning of the new data packet reception starts, counter 161 clocks flip flop 164 which sets the STPLL signal 165. STPLL 165 stops the phase lock loop operation in DCLKPLL 156. After an additional delay, counter 161 clocks flip flop 162 which sets the TIMST signal 163. TIMST 163 enables the start word detect circuit 158 to start looking for the start word of the data packet.

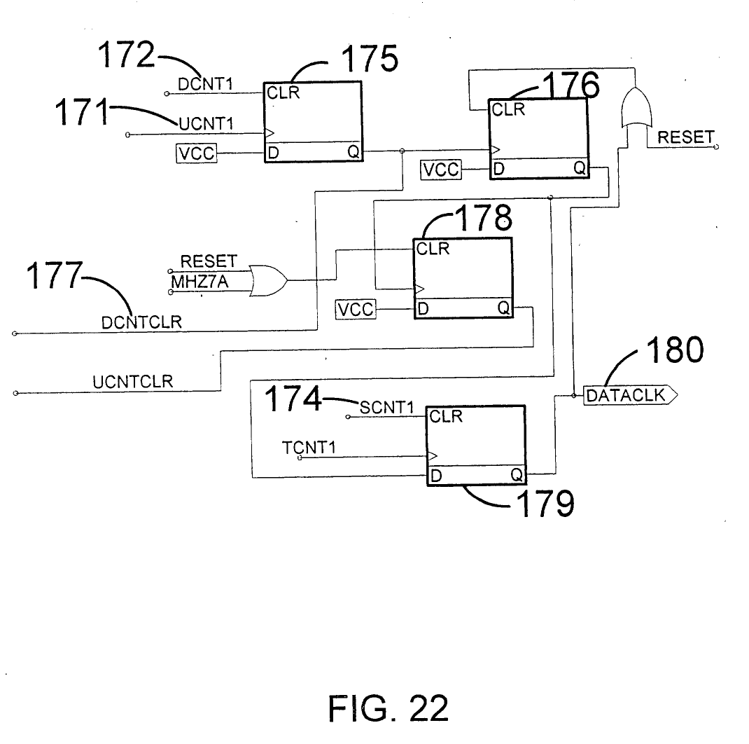

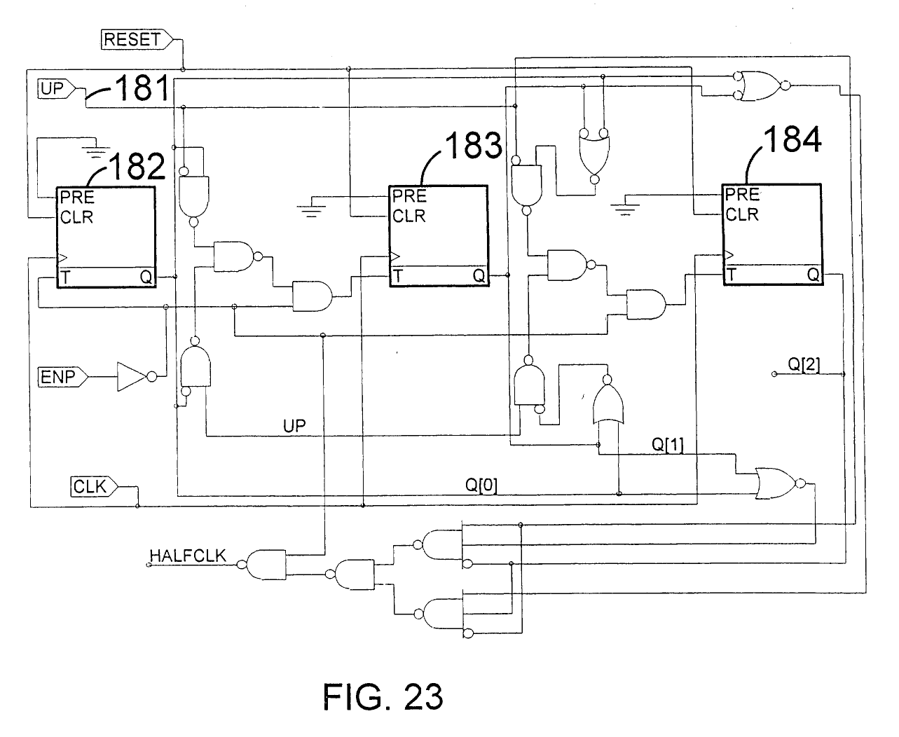

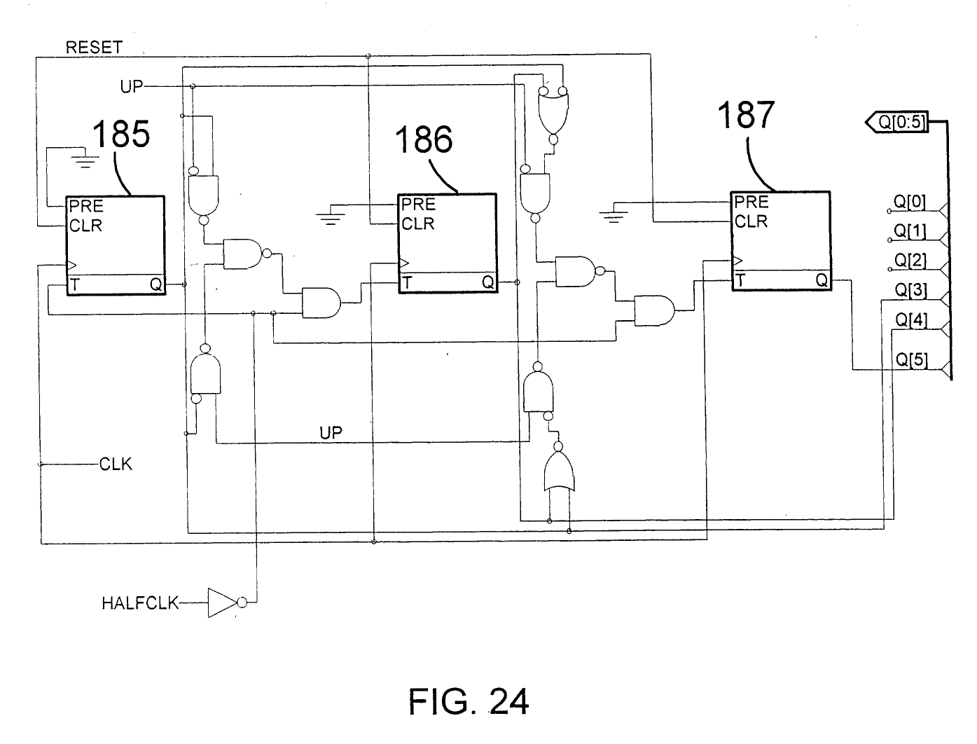

FIGS. 21 and 22 are detailed schematics of CLKREC 157 (FIG. 19). The received RF data signal DATAIN 167 in FIG. 21 goes through gates 168 to an up-down counter 169. Counter 169 is a 6 bit up-down counter that has been reduced from a standard 8 bit up-down counter. FIGS. 23 and 24 are detailed schematics of counter 169 which illustrates the 6 bit counter using flip flops 182,183, 184, 185, 186, and 187. Counter 169 is set up with feed back so that it will never go above a certain number or below a certain number. If these limits are ever reached, the DATAIN 167 is inverted through gates 168 which causes the up-down signal 181 to toggle for one count. This causes the counter 169 to dither back-and-forth at the upper or lower limit until DATAIN 167 changes to a different state. The outputs of counter 169 cause UCNT1171 to clock flip flop 175 several counts below the upper limit and cause DCNT1 172 to clear flip flop 175 several counts above the lower limit. The output of flip flop 175 is the recovered clock from the RF data stream 167. To compensate for this phase delay, flip flops 176, 178, and 179 with counter 170 start a delay function after the rising edge of DCNTCLR 177. When counter 170 counts to the right time delay, it causes TCNT 173 to go high which in turn clocks flip flop 179 to go high. Counter 170 continues to count for the time period of one half cycle of the expected received RF data rate. At this half cycle time period, SCNT 174 goes high to clear Flip flop 179. Thus, DATACLK 180 is a square wave clock signal that is in phase and at the same frequency as the clock signal contained in the received RF data stream.

The above technique is used in the preferred embodiment because it helps to recover the received RF data clock in a high noise environment. Other methods can be used to recover the received RF data clock such as first edge detection, analog phase lock loops, or Digital Signal Processing algorithms and still work in this system.

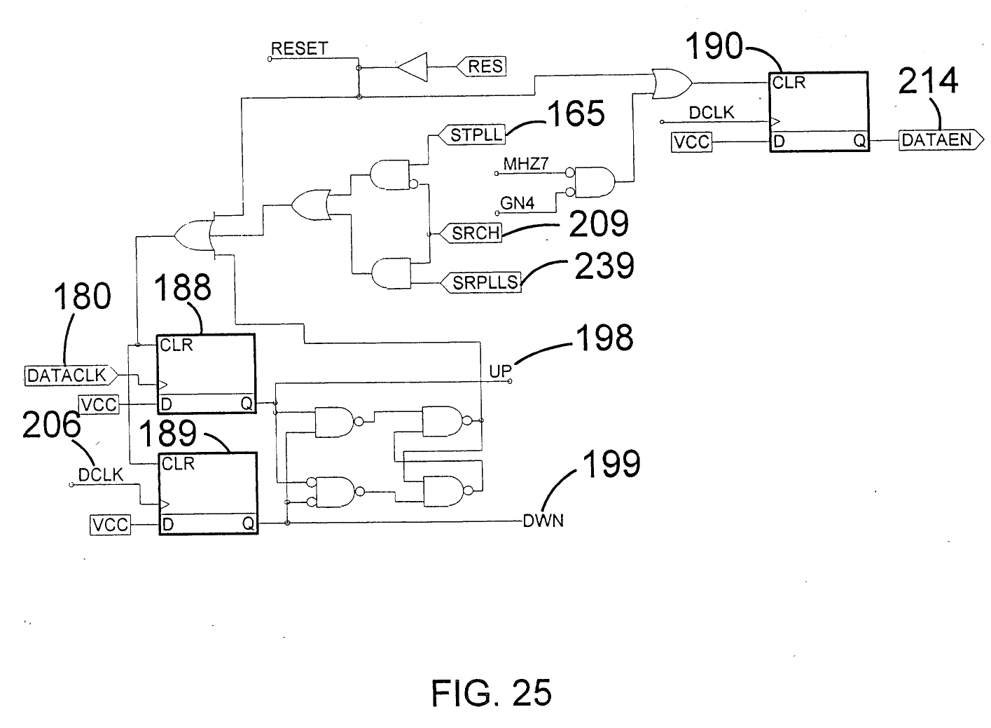

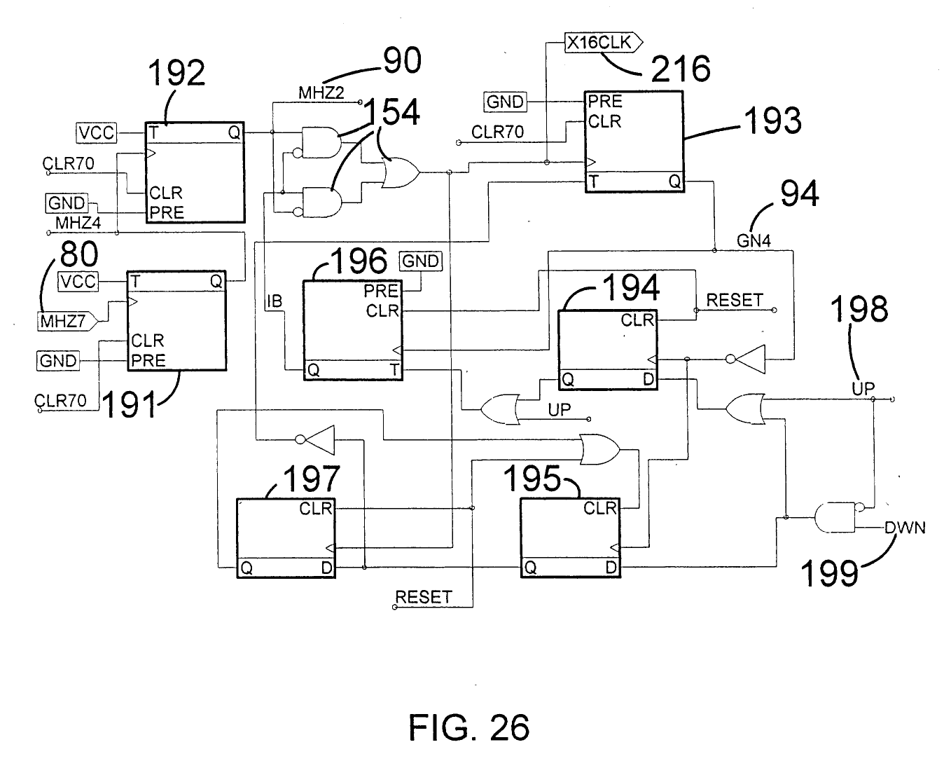

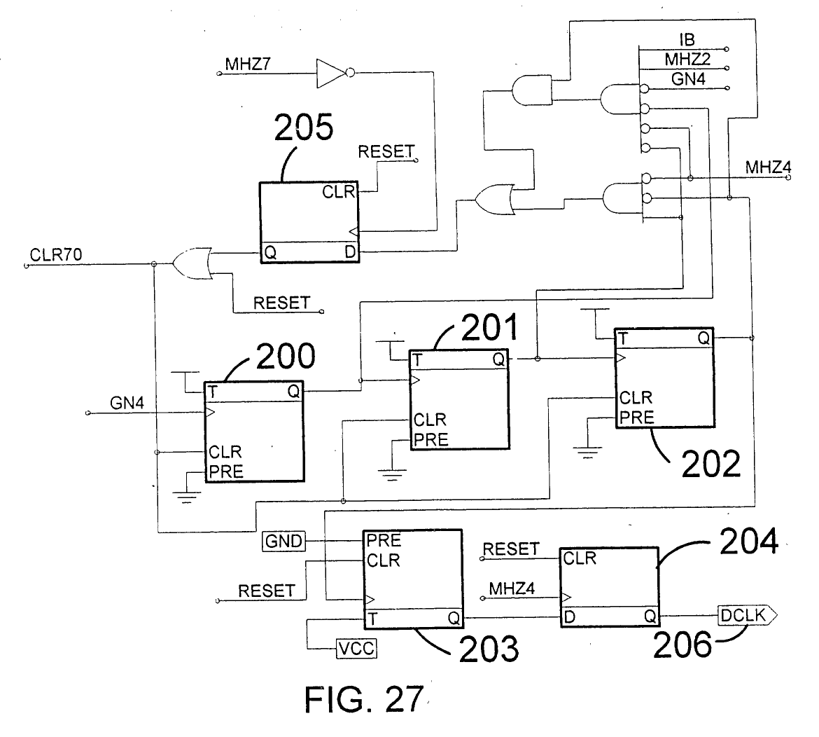

Once the received RF data clock is recovered in DATACLK 180, it Is fed into the DCLKPLL circuit 156 of FIG. 19. FIGS. 25, 26, and 27 are detailed schematics of the DCLKPLL circuit 156. Flip flops 191,192,193, and 200-204 constitute a ripple counter structure that divides the reference frequency 80 down to the RF data clock 206. This DCLK 206 must be brought in phase with the received RF data clock DATACLK 180. When the start word byte and other data comes in on the RF data stream, the DCLK 206 will be used to decode and clock in the received RF data. The DCLK 206 goes into a phase detector made up of flip flops 189 and 188. The DATACLK signal 180 is used as the reference signal into the same phase detector. When DCLK 206 is lagging behind DATACLK 180, the UP signal 198 goes high. When DCLK 206 is ahead of DATACLK 180, the DWN signal 199 goes high. A high on UP signal 198 or DWN signal 199 allows the output of flip flop 194 to go high when GN4 94 goes low. When GN4 94 goes high again, flip flop 196 will go high which toggles digital switch 154. Toggling digital switch 154 causes the clock going into flip flop 193 to invert from high to low. This will cause the frequency coming out of flip flop 193 to speed up by one half of a cycle of MHZ2 90 which in turn causes DCLK 206 to speed up. A high on DWN signal 199 causes output of flip flop 195 to go high so that flip flop 193 will not toggle for one of its clock cycles. The effect of this is that the frequency coming out of flip flop 193 slows down by one half of a cycle of MHZ2 90. Flip flop 197 is used for clearing flip flop 195 at the appropriate time. This circuit will bring DCLK 206 in phase with DATACLK 180. The phase lock loop is turned off when the timer signal STPLL 165 goes high or when a string of zeros is detected by the STRBYTE circuit 158. DATAEN 214 is created using flip flop 190. DATAEN 214 is used in circuit STRBYTE 158 to indicate that another RF data bit is coming.

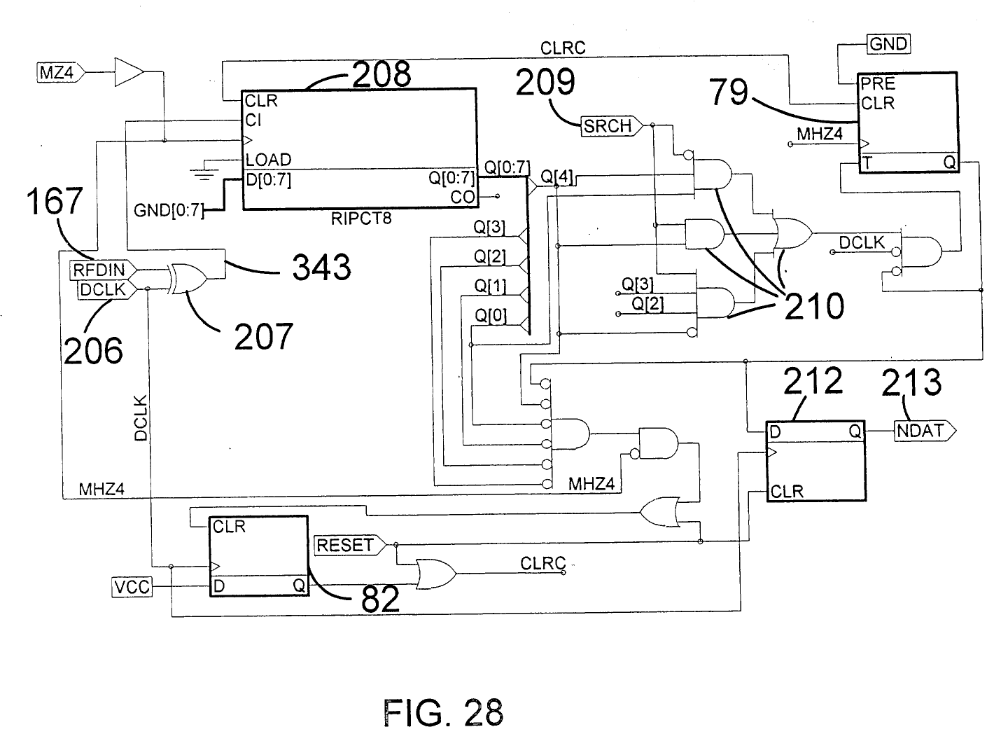

With the received data clock is recovered and phase locked to DCLK 206, circuitry in NDAT 159 is ready to decode the data bits from RFDIN 167. FIG. 28 is the detailed schematic of the NDAT circuit 159. In FIG. 28, RFDIN 167 and DCLK 206 are input to gate 207 to decode the data from Manchester encoded data. In the preferred embodiment, Manchester encoding is used to send data over the RF channel. Other types of encoding (or no encoding) can be used to eliminate the need for gate 207. The output of gate 207 is signal 343 which is the decoded data. Counter 208 does a form of digital filtering on decoded data signal 343. The counter 208 is cleared when DCLK 206 clocks the output of flip flop 82 high. When decoded data signal 343 is high, counter 208 is enabled to count. If decoded data signal 343 stays high longer than it is low during a DCLK 206 cycle, a high is clocked through flip flops 79 and 212 onto NDAT 213. This means that NDAT 213 is the filtered and decoded data. During the first 500 microseconds of a transmission, all zeros are received by this circuit. While searching for this string of zeros, the signal SRCH 209 stays high. While SRCH 209 is high, selector 210 changes the filter counter which determines whether a one or a zero bit is received. This special filtered method helps improve the performance of the system in high noise environments for detecting the 500 microseconds of lead-in zeros to a packet. When Manchester encoded, these same zeros are the received data clocks used by CLKREC 157.

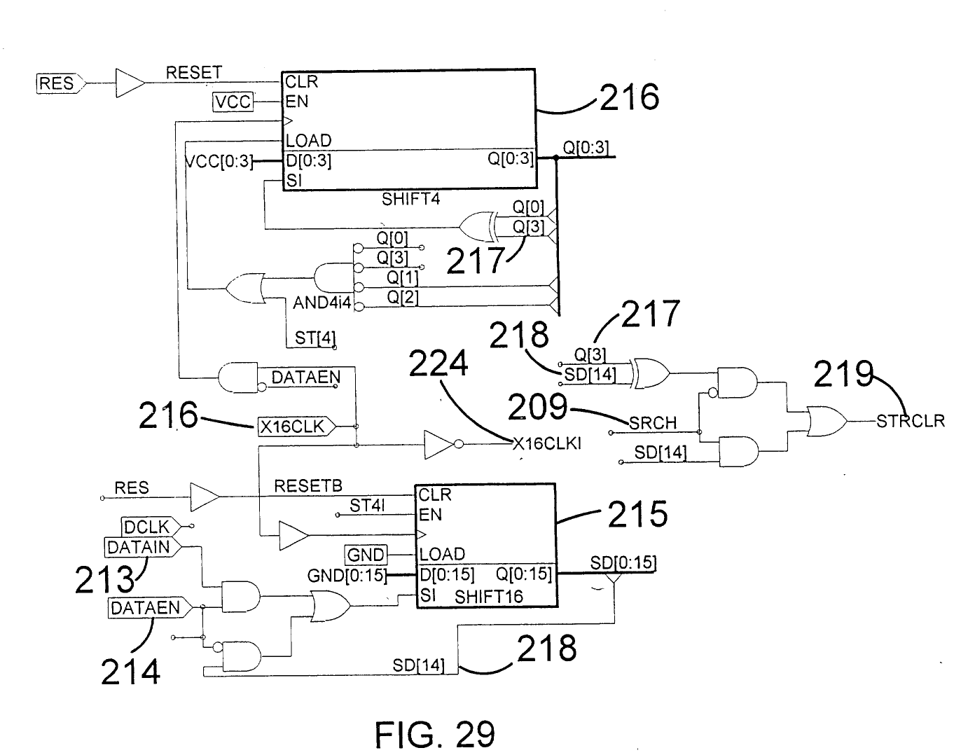

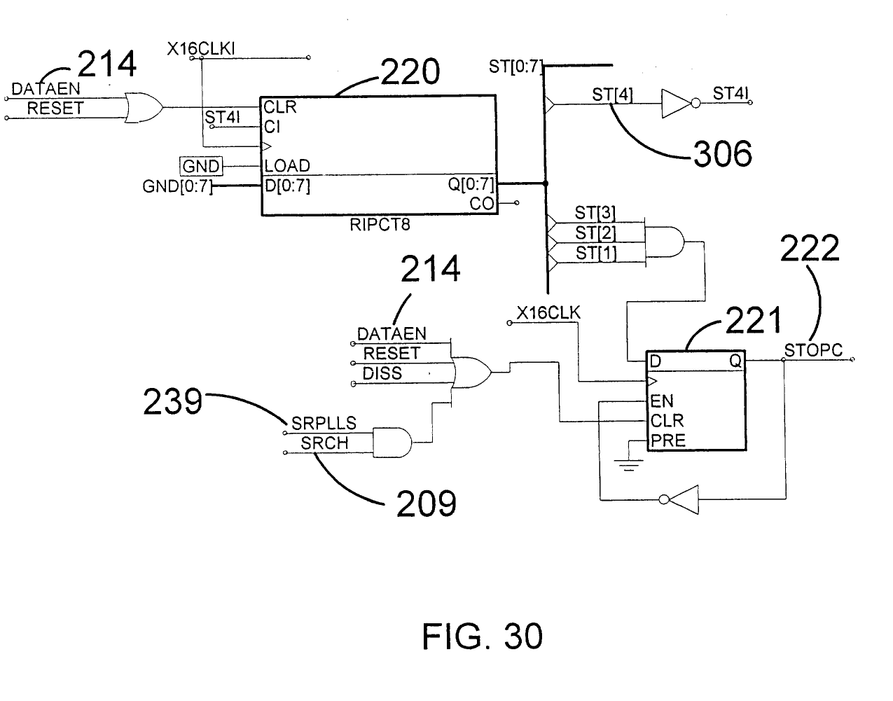

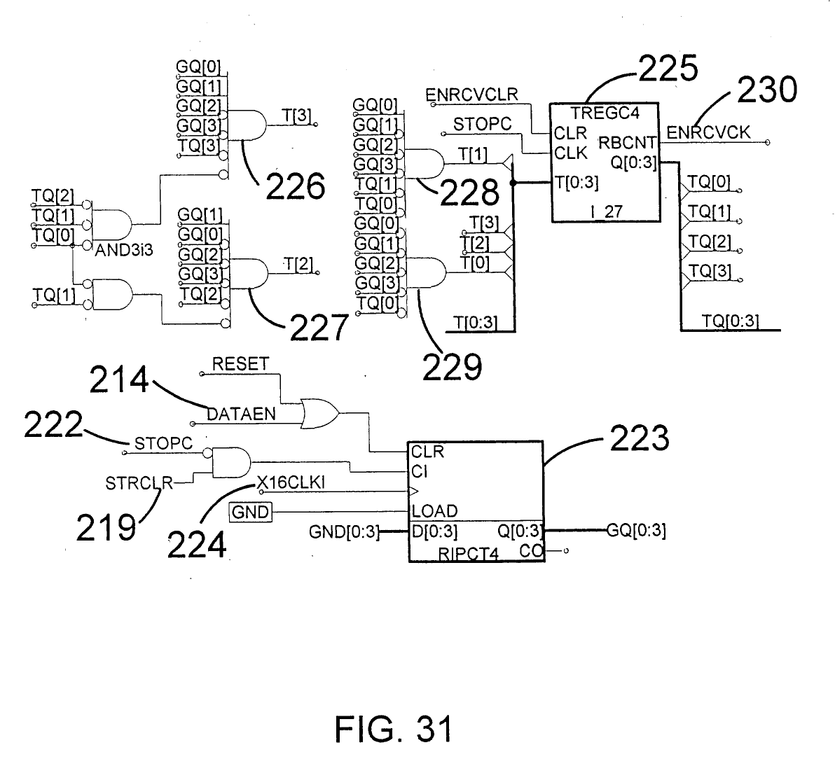

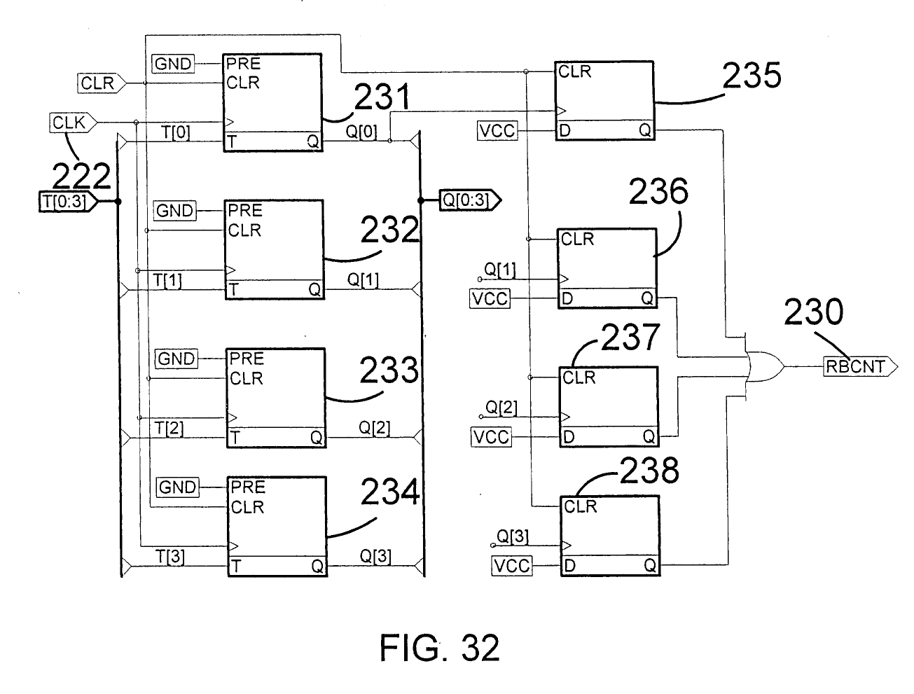

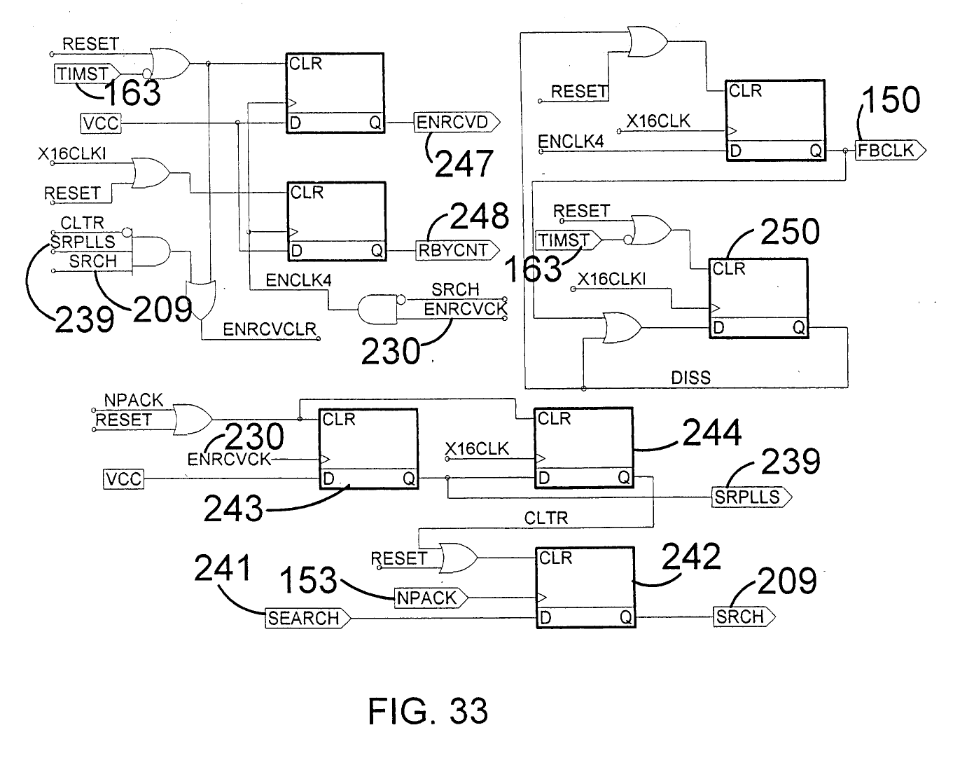

NDAT 213 goes to the start word detect circuit 158 on FIG. 19. FIGS. 29, 30, 31, and 33 are the detailed schematics of the STRBYTE circuit 158. NDAT 213 (also called DATAIN) is clocked into shift register 215 when DATAEN 214 goes high. X16CLK 216 is a clock signal that is 16 times faster than DCLK 206. X16CLK 216 is the clock signal for shift register 215. Therefore, shift register 215 will receive 16 clocks between each new bit of data. The shift register 215 is a 15 bit recirculating register that always shifts out of SD[14] 218 the last 15 bits of NDAT 213 received. Normally 16 shifts would take place but counter 220 (FIG. 30) stops the shifts when ST[4} 306 goes high. Counter 223 (FIG. 31) increments by one, whenever STOPC 222 is low and STRCLK 219 is high. During the first 500 microseconds of transmission, STRCLK 219 is selected to be the same as SD[14] 218 by SRCH 209. Therefore, counter 223 counts how many ones are in the last 15 bits of NDAT 213. Counter 223 is cleared to start the count again each time a new NDAT 213 bit is loaded by DATAEN 214. Circuits 226, 227, 228, 229, and 225 set ENRCVCK 230 high if at least 12 of the last 15 bits received in NDAT 213 were zeros. FIG. 32 is a detailed schematic of TREGC4 225. At the end of checking the last 15 bits received in NDAT 213, the signal STOPC 222, which is created from flip flop 221, clocks the data from circuit 226, 227, 228, and 229 into flip flops 231, 232, 233, and 234. These in turn, clock flip flops 235, 236, 237, and 238 to have high outputs if any of the flip flops 231-234 were triggered high. If any of the flip flops 235-238 are high, ENRCVCK 230 will go high. The first time that ENRCVCK 230 goes high during the first 500 microseconds of a transmission, indicates that the DCLK 206 is phase locked to the DATACLK 180. In FIG. 33, ENRCVCK 230 then clocks flip flop 243 which causes SRPLLS 239 to go high. A high on SRPLLS 239 will stop the phase comparator in FIG. 25 and causes SRCH 209 to be cleared through flip flops 244 and 242. SRCH 209 was initially set by microprocessor 307 programming the signal SEARCH 241 high and toggling NPACK 153 to go high then low twice.

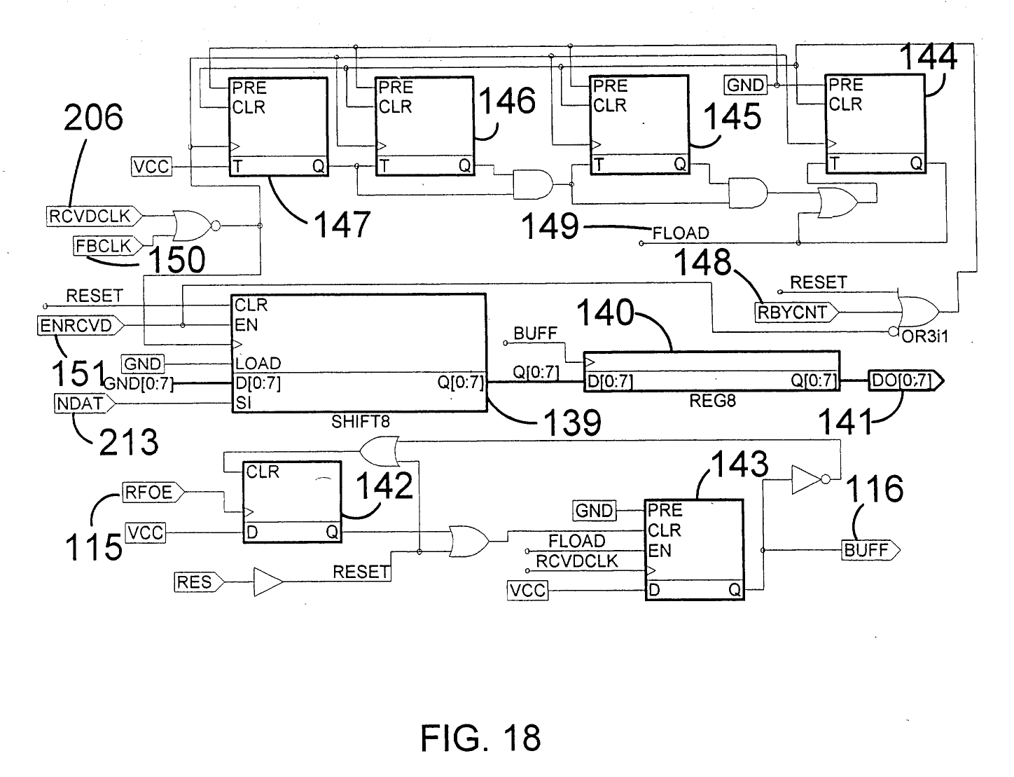

After SRPLLS 239 goes high, ENRCVCK 230 will be cleared and the search for the start word will begin. The start word is created by shift register 216 using feed back Q[3]217 (FIG. 29). This forms a 15 bit long pseudo-random number generator. A longer generator could have been used or a simple shift register that is loaded with the start bits could have been used instead of shift register 216. The start word is shifted out of shift register 216 through Q[3] 217 and compared with SD[14] 218. The result of this comparison comes out on STRCLR 219. Whenever Q[3] 217 and SD[14] 218 are not equal, counter 223 will be increment. Circuits 226, 227, 228, 229, and 225 sets ENRCVCK 230 high if at least 12 of the last 15 bits received in NDAT 213 are equal to the start word. When ENRCVCK 230 goes high because the start word matches the received NDAT 213 bits, ENRCVD 247, RBYCNT 248 and FBCLK 150 go high. These signals are used in FIG. 18 for getting the first byte of RF data.

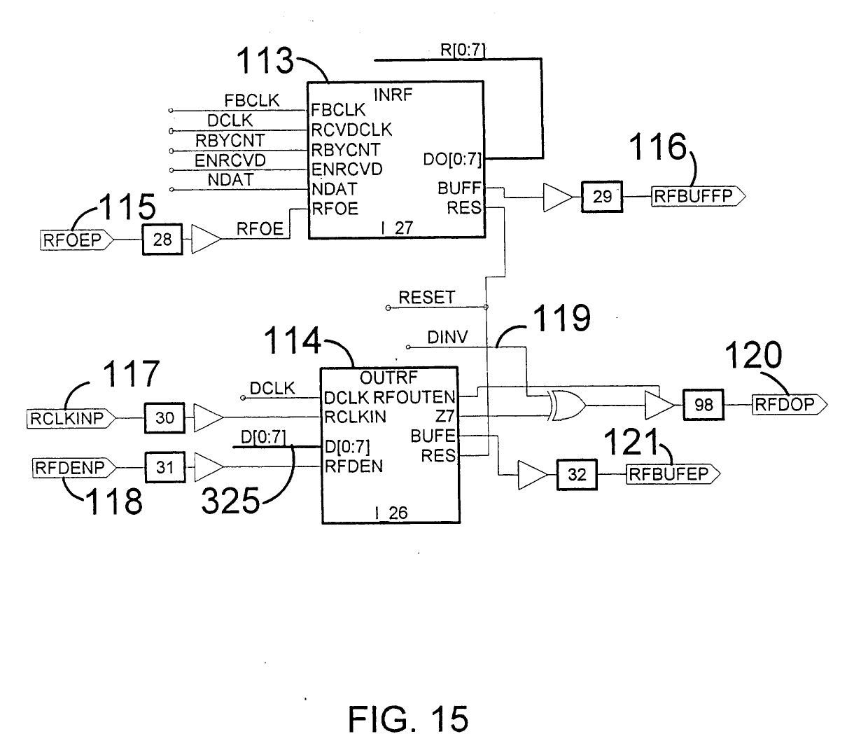

FIG. 15 shows the upper level schematic for a microprocessor interface to the RF data. FIG. 18 is the detailed schematic of the INRF 113 which brings the received RF data in on NDAT 213 and converts the data into a parallel format. The data is then read in and buffered by microprocessor 307. After being buffered, the data is sent to the appropriate codec in the preferred embodiment. In other embodiments, the data can be sent to a modem or other device.

In FIG. 18, RCVDCLK 206 or FBCLK 150 clocks serial data NDAT 213 into shift register 139. When shift register 139 is full, the byte of data is loaded into register 140 by the buffer-full signal 116. The buffer-full signal 116 is created by FLOAD 149 allowing flip flop 143 to be clocked. A high on the output of flip flop 143 is a buffer-full signal 116 for the microprocessor 307. After reading the data, the microprocessor 307 clears flip flop 143 by setting flip flop 142 with RFOE 115. Data is only allowed to be clocked into register 139 when ENRCVD 151 is high. FBCLK 150 clocks the first bit of data into shift register 139 after detecting the start byte in FIG. 33. The FLOAD signal 149 is created by the counter made up of flip flops 144, 145, 146, and 147 which counts the number of bits that have been shifted into shift register 139. RBYCNT 148 resets and synchronizes flip flops 144, 145, 146, and 147 to the first received data bit on NDAT 213.

FIG. 15 shows the upper level of how the microprocessor 307 clocks parallel RF data into FPGA 308 by using data bus 325 and clock signal RCLKIN 117. OUTRF 114 then converts the parallel RF data to serial data and shifts this data to the RF section on signal RFDOP 120. When the RF buffer is ready for more data, it sends a buffer-empty signal RFBUFEP 121 to the microprocessor 307. DINV 119 is controlled by the microprocessor 307. It inverts the data going to the RF section depending on which channel the frequency hopping transmitter is transmitting.

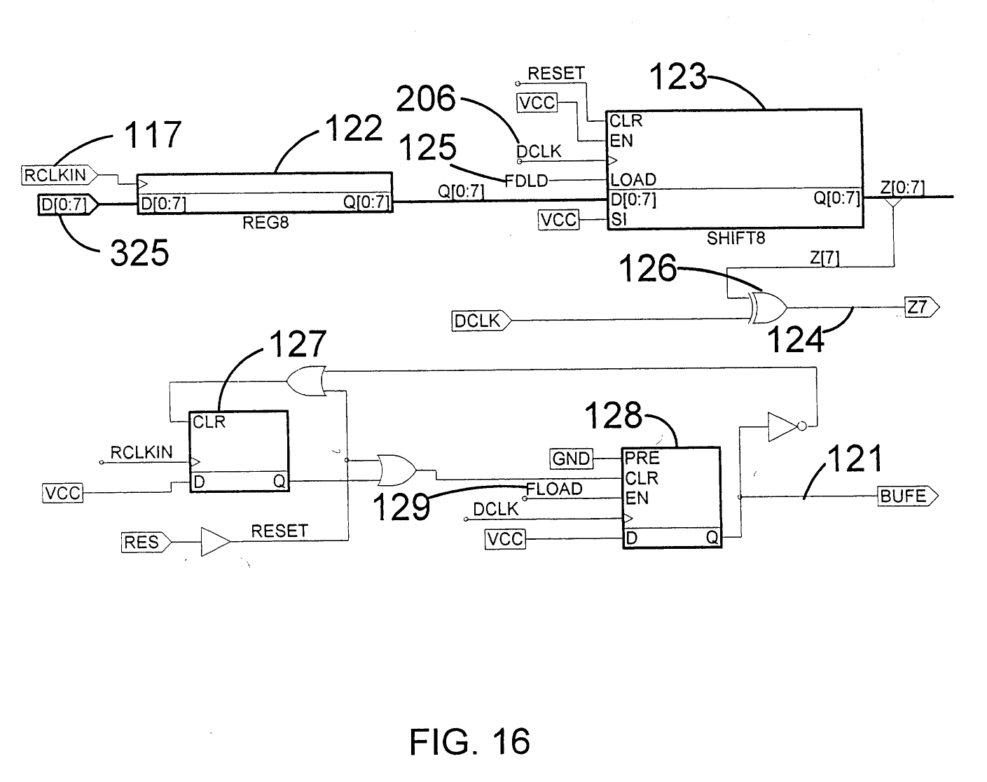

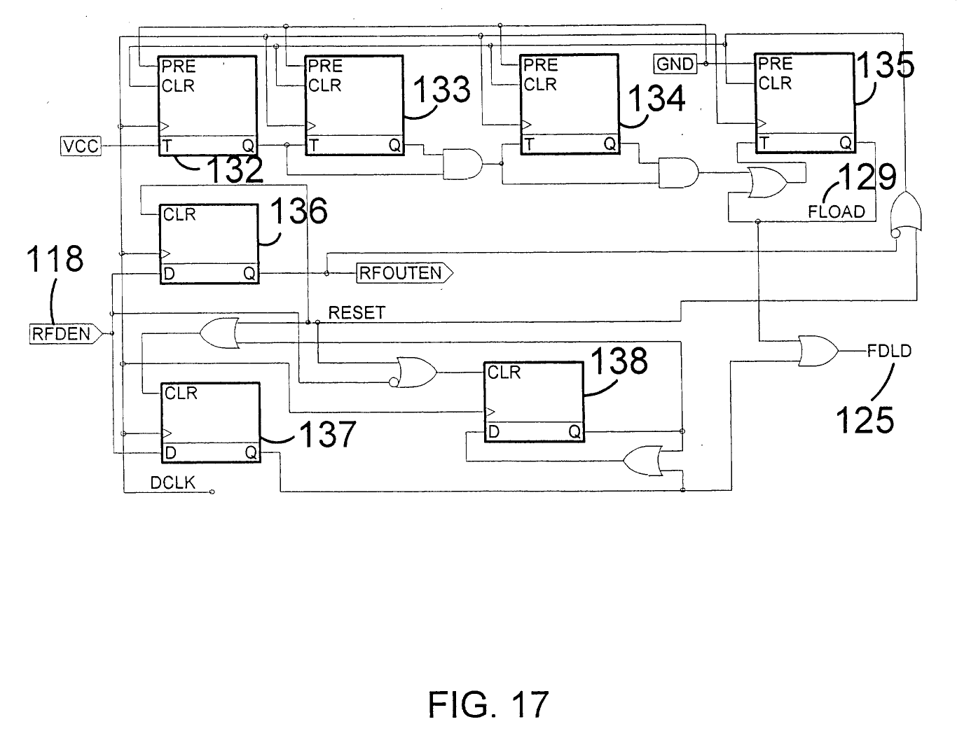

FIG. 16 and FIG. 17 are schematics of the circuits inside OUTRF 114 and show how the data is double buffered. When the circuit sends a buffer-empty signal 121 out of flip flop 128, the microprocessor 307 clocks a new data byte into register 122 with clock RCLKIN 117. RCLKIN 117 triggers flip flop 127 to clear flip flop 128. The data is held in register 122 until shift register 123 shifts out its last bit at which time FLOAD 129 loads the data from register 122 into shift register 123 and triggers flip flop 128 to send the buffer-empty signal BUFE 121. Clock signal DCLK 206 controls the data rate for shifting data out of shift register 123. After the RF data is shifted out of shift register 123, it passes through encoder 126 where the data is Manchester encoded and sent out on signal Z7 124.

FIG. 17 includes a counter with flip flops 132, 133, 134, and 135 which counts the number of bits shifted out of shift register 123. When all the bits are shifted out of shift register 123, FLOAD 129 goes high and loads shift register 123 with another byte of data. When microprocessor 307 wants to send the first byte of a data packet, it sets RFDEN 118 high. A high on RFDEN 118 pulls RFDOP 120 out of tri-state through flip flop 136. RFDEN 118 also resets and synchronizes the counter made up of flip flops 132, 133, 134, and 135 to the first byte of data through flip flops 136, 137, and 138 and the signal FDLD 125.

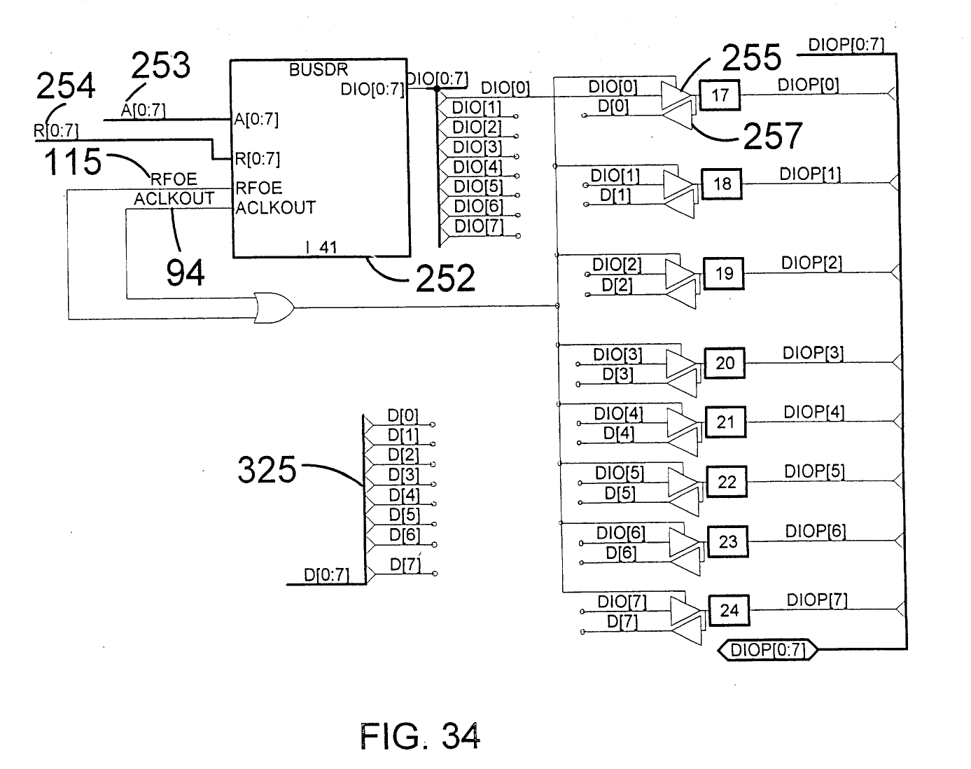

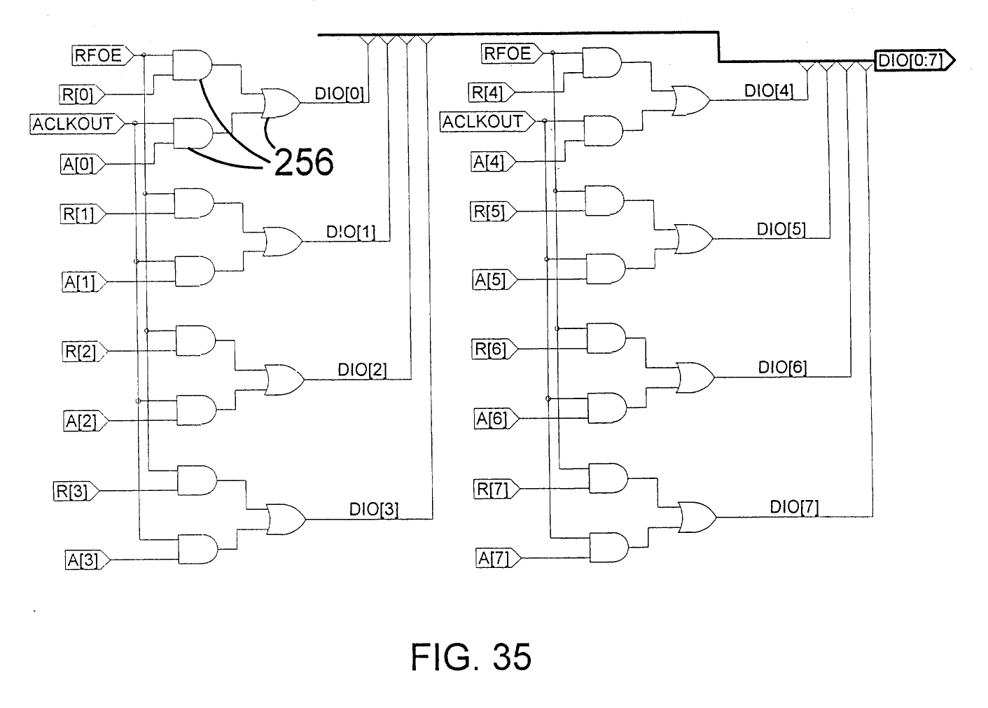

FIG. 34 is a schematic of the data bus interface to microprocessor 307. Tri-state driver 255 sends data to microprocessor 307 from BUSDR 252. There is a tri-state driver 255 for each data bit. Buffer 257 sends data from microprocessor 307 to data bus 325. FIG. 35 is a detailed schematic of BUSDR 252. It shows how RFOE 115 and ACLKOUT 94 select between the audio data bus 253 and the RF data bus 254 through 8 selectors like selector 256.

In the preferred embodiment, a frequency hopping spread spectrum system is used to create the communication link for groups of transceivers to communicate to one another. Each transceiver uses the same hopping pattern to communicate to other transceivers. Even transceivers with different group numbers use the same hopping pattern. The timing that a particular group of transceivers is communicating on a particular radio channel is different or delayed compared to another group of transceivers. This allows multiple groups of transceivers to operate at the same time. In an alternate embodiment, different groups of transceivers could use different hopping patterns or hopping patterns which use different channels.

In other embodiments, a direct sequence spread spectrum system could be used in which different groups of transceivers use different spreading codes, different radio channels, and/or time-offset spreading codes to create the different communication links. Starting the spreading sequence at different times to differentiate between different groups of transceivers all having the same spreading code is known as a time-offset spreading code technique.

In another embodiment, multiple master transceivers can be part of the same communication link. One of the master transceivers would be used to time synchronize all the clocks to maintain timing in filling buffers. This timing information can be passed from master transceivers to master transceivers in systems where all the transceivers cannot communicate with one another. The master transceivers can still communicate with one another but each master transceiver can also independently assign slave transceivers to other available slots. All master transceivers need to know which time slots are available to be assigned to other transceivers. This can be done by each master transceiver receiving all the information on the communication link or by special packets received from other master transceivers that hold the time slot assignments associated with each of the other master transceivers. The master transceivers can be limited to specific slots or assigned to any slot by the original master transceiver in the communication link. Each master transceiver can communicate to all other master and slave transceivers. In some applications, the master transceivers can set up mini-communication links to specific time slots in a multiple master transceiver system so that each master transceiver can have private communications with specific slave transceivers. This embodiment can be set up because each transceiver has a unique address or each mini-communications link has its own group number. In these embodiments all transceivers do not have to buffer information from all other transceivers, but only those associated with their mini-communication link.

In embodiments where higher data rates are needed for specific transceivers, multiple time slots can be assigned to individual transceivers. If multiple time slots that are assigned to a transceiver are consecutive, only the first time slot in the consecutive time slot string has to have the clock recover string, the start word, an address or group number, and a command.

In other embodiments, all or part of the analog section 306, the FPGA 308, the microprocessor 307, the audio codecs 309, and the interface to the speaker and microphones can be replaced by a Digital Signal Processor or combination Digital Signal Processor/microprocessor. A Digital Signal Processor could allow for better filtering, better sensitivity in the wireless received data and more functions that are common in telephone applications.

Another application would be to interface one of the transceivers to a telephone line to make a cordless telephone system or a wireless PBX system. In this application, a Digital Signal Processor could also be used for echo canceling and telephone line balancing.

From the above description, it is apparent that other types of radios can be used instead of a frequency hopping spread spectrum radio to create a full duplex conferencing radio system. A single channel radio with enough bandwidth or a direct sequence/code division multiple access (CDMA) spread spectrum radio could also be used.

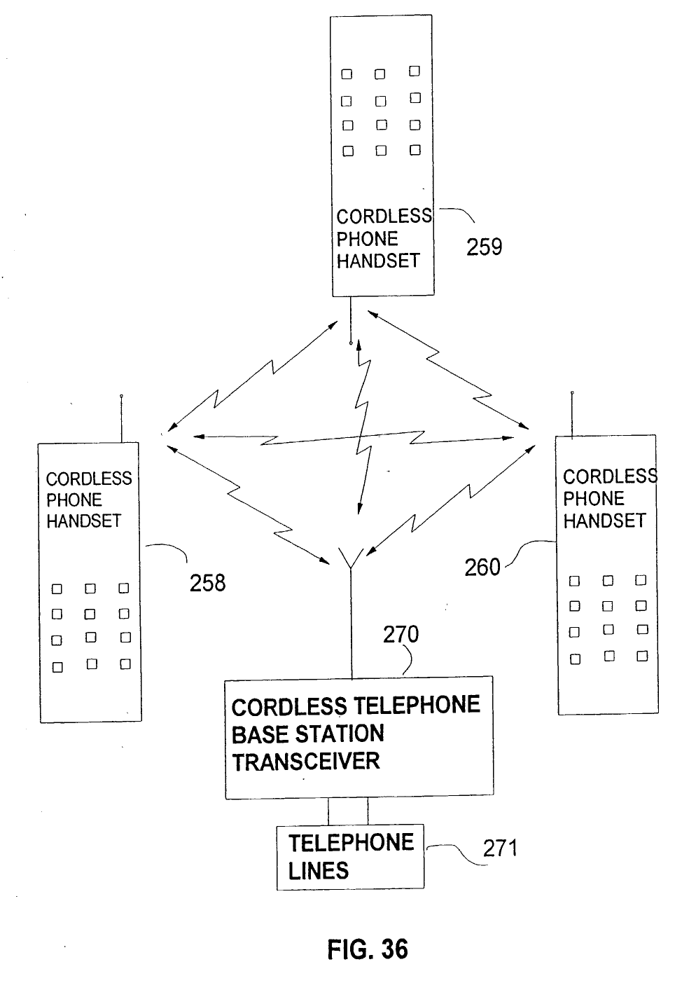

FIG. 36 is a block diagram of an alternative embodiment showing each communication transceiver as a cordless telephone hand set or as a base station to a cordless telephone. Cordless telephone handsets 258, 259, and 260 can communicate to each other in a conference-like manner independent of the base 270 or with the base 270 making the connection to the telephone system 271. In other embodiments, the base 270 and telephone lines, 271 can be replaced with an interface to any other communication system such as business band radio, cellular radios, PBXs, etc.

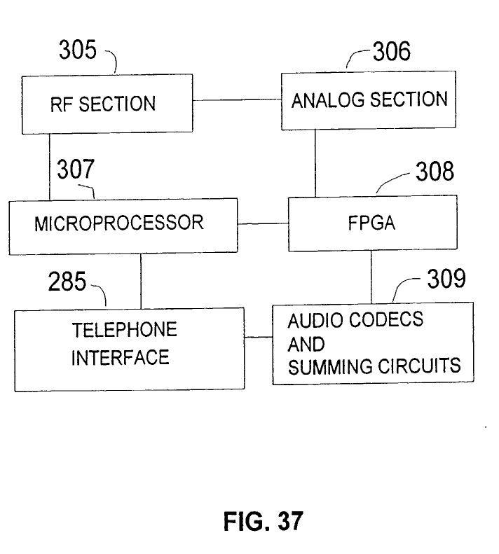

FIG. 37 is a block diagram showing how a communication transceiver is changed to become a cordless telephone base station transceiver 270. Telephone interface 285 replaces the microphone 310 and speaker 311 of FIG. 2 to create a telephone base station 270.

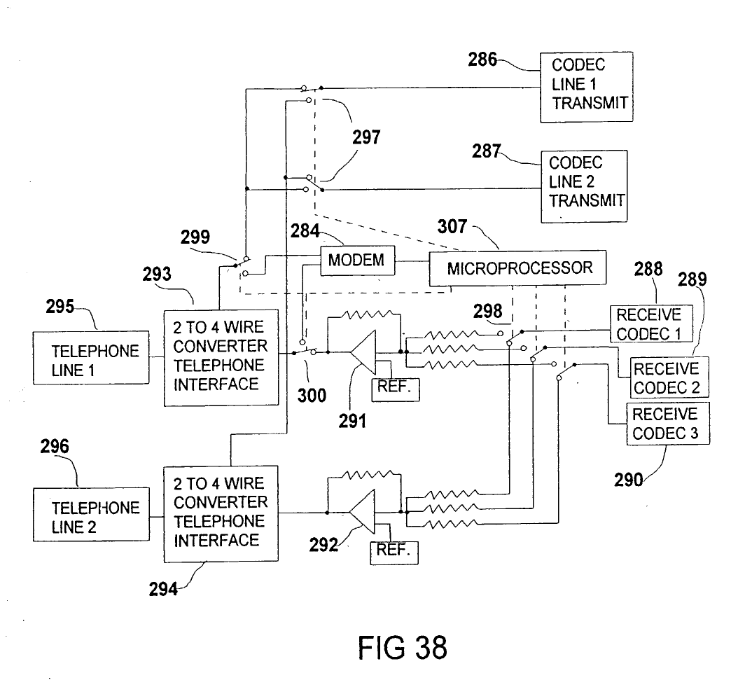

FIG. 38 is a more detailed block diagram of a possible telephone interface showing how to connect two telephone lines to the same system. Telephone lines 295 and 296 each go to their own 2 to 4 wire converters 293 and 294. Microprocessor 307 controls all the on/off hook functions, ring detect functions, etc. of the telephone interfaces 293 and 294. This configuration also shows how a modem 284 could be connected to one of the phone lines 295 for sending the receiving data that can also be sent to the handsets 258, 259, and 260. Whether the modem is used or the codecs are used is controlled by microprocessor 307 through relays 299 and 300. A modem could also be connected to the other phone line 296. Transmit codec 286 and 287 can receive information from telephone line interface 293 or 294 depending on the position of relay 297. This allows for configuration of one transmit codec talking to all or some of the handsets 258, 259, and 260 or each transmit codec 286 and 287 occupying one of the time slots but communicating using different group numbers to individual handset or groups or handsets. Microprocessor 307 controls relay 298 which routes receiving codecs 288, 289, and 290 to the appropriate summing amplifiers 291 and 292. By adding more relays, codecs, telephone line interfaces, telephone lines, and time slots, a conferencing-capable wireless PBX can be implemented.

Program for the 65524 OKI Microcontroller 307 of FIG. 3 in Intel Hex Format:

:100020000001030106010C010F0112011501180165

:100030001B012101240127012A012D013001330177

:0300400080360106

:03006000803601E6

:100100008000018003012C2D95442E83800C0180FA

:100110000F018012018015018018012C2D95442CAF

:1001200083802101802401802701802A01802D0104

:1001300080300180D7052AEF3A2090147F95150072

:10014000E29515F0E3951500E4951500E595150188

:10015000E89515DBE9951500EC9515ACED9515A026

:10016000EE951504B89515FFB9951500BA95150FBC

:10017000BB951502BC951500B795150CAB95150DE3

:10018000AB951520F395150ADA951500F69515002F

:10019000F78844145530C0E8C2FB155EA01513A1C2

:1001A00015AAA21555A32A7F2ABF8E008844896408

:1001B0009788849789A695150F2895150727951573

:1001C0000A3D95150A3695150A3795150A3802AF76

:1001D00014954530951530059515001F9495E0EC64

:1001E0000380B602818E089515FFE514559505E448

:1001F00095A7E295B7E295A4E295B4E295A5E295BC

:10020000B5E295A6E295B6E2143081A808813A02DB

:100210003A4095AE2495AF259515003C9495E5BEE2

:1002200009950B3C95AE2295AF23951501359504A4

:100230002107070795053480FD082A7F2ABF9515F9

:1002400000EE9515ACED951500EC14808122049517

:10025000052095920521148181220495052295920D

:100260000523148281220495052495920525148383

:100270008122049505029592050314848122049439

:100280007955049279AA22951566209515442195F1

:1002900015AA223A408EAA951555238F55951555C6

:1002A0002495155AA252ABF8A009515A0EE9515ACB0

:1002B000ED951500EC82813A02955620299556213C

:1002C000289556222B9556232A9556242D9556254A

:1002D0002C9556022E9556032F951500EE95152058

:1002E000EC95152CED8028039495E0EC389495E777

:1002F000ECF681020595052881FB0495052981FB13

:100300000495052A81FB0495052B81FB0495052C9A

:1003100081FB0495052D81FB0495052E81FB049539

:10032000052F8067038036019495E7ECFB95042840

:10033000812D0595042981260595042A8126059598

:10034000042B81260595042C81260595042D8126F4

:100350000595042E81260595042F81260595E7EC49

:10036000FC95B5EC80E80295B7EC951500EE951577

:10037000ACED951500EC2A7F2ABF95A3EC95A5EC72

:1003800095A7EC95B7EC14309515083B073F0695FB

:10039000A5EC80980395B5PC95A7EC95B7EC951B6B

:1003A0003B3DE995B3EC95562930955628311440DC

:1003B00081860495562B3095562A31144181860446

:1003C00095562D3095562C31144281860495562E23

:1003D0003095562F31144381860495155530951567

:1003E000AA31144481860495A3EC95A5EC95A7EC5D

:1003F00095B7EC14009515083B073F0695A5EC80D2

:10040000050495B5EC95A7EC95B7EC951B3B3DE93C

:1004100095B3EC9515A0EE9515ACED951500EC8017

:10042000B60295A3EC95A5EC95A7EC95B7EC9515C0

:10043000083B073F0695A5EC803E0495B5EC95A7D3

:10044000EC95B7EC951B3B3DE99515083B95A7EC62

:100450009495E6EC053A01805C042AFE920795B774

:10046000EC951B3B3DE79515083B95A7EC9495E66D

:10047000EC053A018079042AFE0795B7EC951 B3B011

:100480003DE895B3EC8295A3EC95A5EC95A7EC958A

:10049000B7EC9515083B073F0695A5EC80A204959F

:1004A000B5EC95A7EC95B7EC951B3B3DE995043170

:1004B0009515083B073F0695A5EC80C00495B5EC63

:1004C00095A7EC95B7EC951B3B3DE9950430951548

:1004D000083B073F0695A5EC80DE0495B5EC95A793

:1004E000EC95B7EC951B3B3DE99583EC95B7EC95D6

:1004F000A3EC9495E6ECFB95B3EC829515083B8054

:100500000E059515073B140195E6EC02140095E7DE

:10051000ECFC9495E7ECFB3A0195E6EC022AFE0729

:10052000951B3B3DE9829515083B803A05951507DB

:100530003B95A5EC073E0395B5EC95E7ECFC94954F

:10054000E7ECFB95A5EC073E0395B5EC951B3B3D11

:10055000E9829495E0BE7F2D2ABF94EA011D95158E

:1005600000E595A7E89504E4973197C1957BC2090A

:100570003E039789A695B7E88095059515FFE59701

:10058000219505E495A7E295B7E297C1957BC2094D

:100590003E039789A69515FFE5209505E495A4E20D

:1005A00095B4E2C0957B60003E028844219505E445

:1005B00095A5E295B5E2C1957B80013E02896497DD

:1005C000209505E495A6E295B6E297C0957BA00834

:1005D0003E039788842F829495E0BE7C2C2D2ABF01

:1005E00094EA0118951500E595A7E89504E497317C

:1005F00097C195B7E89515FFE5800D069515FFE5C0

:1006000097219505E495A7E295B7F297C120950556

:10061000E495A4E295B4E2C0219505E495A5E295A0

:10062000B5E2C197209505E495A6E295B6E297C09C

:1006300095E0F522957BC2093E039789A6957B60DC

:10064000003E028844957B80013E028964957BA030

:10065000083E039788842F2E3A10823A4014228154

:10066000E906140781E90614A081E90695A1B89569

:10067000B1B8140081E906140081E906149081E9FB

:100680000695A1B895B1B892CB951506FE95920541

:10069000FC9505F89795AAFC9795ABFD5338072371

:1006A00081E906950B1A3D0297C32381E906950B54

:1006B0001A3D0297C32381E90695A1B895B1B89573

:1006C0000B1A3D0297C32381E906950B1A3D029749

:1006D000C32381E906950B1A3D0297C32381E906DE

:1006E00095A1B8716695B1B8829505E195E4E0FCF5

:0506F000820B300F2C0D

:1006F5000D2A132E11151E191720221B242604332B

:1007050008370635020E290C2D122F102B181F162F

:100715001C23271A212509320536033407380A1404

:100725001D28310139406080A04060800001080922

:1007350000000003FF8412000003FF841200300351

:10074500FF8412006003FF8340001003FF83400015

:100755004003FF8340007003FF8420012003FF84D2

:1007650020015003FF8421000003FF842100300392

:10077500FF8421006003FF8501011003FF8501014E

:100785004003FF8501017003FF8502002003FF85FB

:1007950002005003FF8430000003FF843000300363

:1007A500FF8430006003FF8510011003FF851001F1

:1007B5004003FF8510017003FF8511002003FF85AD

:1007C50011005000FF8601010000FF860101300085

:1007D500FF8601016000FF8602001000FF8602000F

:1007E5004000FF8602007003FF8520002003FF857F

:1007F50020005003FF8600010003FF86000130033F

:10080500FF8600016003FF8601001003FF860100DB

:100815004003FF8601007001FF8005052001FF8070

:1008250005055001FF8006040001FF800604300124

:10083500FF8006046003FF8610001003FF8610008A

:100845004003FF8610007000FF8700012000FF872E

:1008550000015000FF8701000000FF870100300004

:10086500FF8701006001FF800A001001FF800A0078

:100875004001FF800A007002FF8007022002FF800E

:1008850007025003FF87000000951508E095A4B8FE

:100895009515C0E195E4E0FC95B4B895A4B8951517

:1008A50000E08295A0BA9505E195E4E0FC95B0BA23

:1008B500822F2E2E3A4097C69794EE4C03802B0933

:1008C5002ABFC4EC01083A4097881D800D09EC0247

:1008D500083A40978824800D09EC03083A40978828

:1008E50011800D09EC04083A40978801800D09EA4A

:1008F500010380FD08806D0B2AEF2ABF95B7F78CA1

:10090500008A003A409788002AEF3A4097C897DA5C

:10091500978B0053F10623196918DB3F035930DB28

:10092500815B06978E002AEF95A2F6951500DD9559

:10093500B2F495150BDB02B60895452E2AEF95A264

:10094500F6950405391081A80895A1E895B1E895B3

:10095500A1E895B1E895B0F53A4089408C2002D8D8

:100965000E95452C95A6E895B6E895A0F795A1C7EF

:10097500147F05429789009515032A95151007954B

:1009850015013A3A109504147900602AEF9515FF80

:10099500E514559505E495A7E295B7E295A4E2958A

:1009A500B4E295A5E295B5E295A6E295B6E23A10D0

:1009B5009504AE979569393E06690C3F103E04953E

:1009C50056AE399495E2E2BD951B073DB89556AEF6

:1009D500392AEF95A1E895B1E895A1E895B1E89593

:1009E500B0F53A1095152007808A093A40EA0105C5

:1009F5002AEF802B099515003A0442792C03808B48

:100A05000A2AEF9515A9DD95B2F495150BDB95B27C

:100A500289495E2F4FB95A1E895B1E895A1E895B0

:100A2500B1E895A2F69515D8DD95B2F495150BDBD1

:100A350002B51395452E02D80E95452C95A1C7955F

:100A4500A0BA9504059505E195E4E0FC95B0BA9545

:100A5500A6E895B6E89515012B9515000695B0F510

:100A650095A0F73A4089409789029515012A2ABF32

:100A7500885C897597888E9789A93A10142005A4F2

:100A85002605A580281494792D22898097890195BA

:100A950015022A95B1282ABF884E896797889C97A1

:100AA50089B7142105A42605A580281494792E223A

:100AB50089609789019515032A95B0282ABF88472B

:100AC500897C9788959789B0142205A42605A58069

:100AD500281494792F1D89809789029515032A95E5

:100AE500B0282ABF884E896797889C9789B73A406E

:100AF50080600B9479301D89A09789039515032A89

:100B050095B0282ABF8855896E9788879789BE3AF8

:100B15004080600B9479314797C097C897DA978BD7

:100B25000053F10623196918DB3F035930DB818730

:100B35000695A0BA9504059505E195E4E0FC95B008

:100B4500BA89409789009515032A95B0282ABF8848

:100B55005C897597888E9789A93A402ABF3A403AA9

:100B65004097C02AEF800D099515003A3A409789BC

:100B7500009515002A2ABF8A00885C897597888E9A

:100B85009789A93A40142C05A42605A597881E9790

:100B9500C897DA978B0053F10623196918DB3F03D1

:100BA5005930DB81870695A2F69515D8DD95B2F407

:100BB50095150BDB02430E95452E95B0F73A10803F

:100BC50031142ABF155EA01513A13A40CE05A2CF58

:100BD50005A304A42605A52679200779210494797F

:100BE500220A95042005A695042105A795042A3D0A

:100BF5004195040979BE0D3F269495E0BEFB8152CF

:100C05000580F60B9495E0BEFB9515BEDD95B2F417

:100C150095150ADB8152059495E2F4FB80A40C95A9

:100C250015BF099515560095156F0195158808800E

:100C3500A40C9495E2E8FB9515FFE514009505E4F1

:100C450095A4E895B4E89495E0BE03815205949582

:100C5500E2E8FB9515FFE514009505E495A4E895F4

:100C6500B4E89495E2E8FB9515FFE514009505E4D5

:100C750095A4E895B4E89495E0BE03815205949552

:100C8500E2E8FB9515FFE514009505E495A4E895C4

:100C9500B4E89495E2E8FB95A4E895B4E8712F953E

:100CA500B3E83A4088A0209505E495A4E895B4E812

:100CB500710195A3E8C0710E209505E495A4E8950A

:100CC500B4E8C08D00023E0D95450E14559505E41A

:100CD50095A7E295B7E29495E0BE552ABF95150014

:040CE500E595A7E802

:100CE9009504E4973197C197E9C2039789A695B707

:100CF900E89515FFE5209505E495A4E295B4E2C0D1

:100D0900E860028844219505E495A5E295B5E2C11C

:100D1900E98002896497209505E495A6E295B6E2F3

:100D290097C097E8A00397888480280E3A40ED0081

:100D39007A95440E839794E90303808D0D97C097A4

:100D4900E83206978800978F00025B0D95450E8063

:100D5900280E94E7421897CF97DA978B0053230709

:100D69002319DB97C7028D0D95450E80280E97C86C

:100D790097DA978B0053F1062319DB028D0D954500

:100D89000E80280ECB69189505FC3F05593095054D

:100D9900FC951506FE9505F89795AAFC9795ABFD68

:100DA900533807239505E1C580280EED011395E415

:100DB900E06D950B1A3D0297C3239505E1C580287F

:100DC9000EED021395E4E057950B1A3D0297C323E4

:100DD9009505E1C580280EED031995E4E04195A13B

:100DE900B895B1B8950B1A3D0297C3239505E1C58E

:100DF90080280EED041395E4E025950B1A3D029722

:100E0900C3239505E1C580280EED051395E4E00F90

:100E1900950B1A3D0297C3239505E1C580280E95C8

:100E2900E2E80380DB0C3A40209505E495A4E895B7

:100E3900B4E8C094E8C40380DB0C3A4095B3E89564

:100E4900B0B895A1E895B1E895A1E895B1E895A064

:100E5900E895A1B8710395B1B895A2F69515D8DDB5

:100E690095B2F495150BDBB7A495B50597C197E92C

:100E7906040397890097C992279795692A3F029297

:100E89001997DA9792DB532D0723D980421302B5BC

:100E99001395452E02D80E95452C95A0F795A1C717

:100EA90095A0BA9504059505E195E4E0FC95B0BADD

:100EB90095A6E895B6E89515002B9515000695A712

:100EC900F795B0F595B7F58152052F2E3A10823A6C

:100ED90040951500E595A6E89504E43195B6E8C175

:100EE90095B7F795B2F695B0F73A40951500068D86

:100EF900018A008C1F02B30F95450E957BC2093EEE

:100F0900039789A6957B60003E028844957B800102

:100F19003E028964957BA0083E039788849495E0F6

:100F2900BE7B2AEF951500DC2ABFEA011B9515FF48

:100F3900E597219505E495A7E295B7E297C197E969

:100F4900C2229789A6806D0F951500E595A7E895AA

:100F590004E4973197C197E9C2039789A695B7E841

:100F69009515FFE5209505E495A4E295B4E2C0E85E

:100F790060028844219505E495A5E295B5E2C1E9A9

:100F89008002896497209505E495A6E295B6E297D3

:100F9900C097E8A0039788843A1080CA113A409410

:100FA900ED000380CA1195440E839794E9030380E9

:100FB9004B1097C097E83206978800978F009504E1

:100FC9002A79000902051095450E80CA1102DF0F22

:100FD90095450E80CA1197C097C897D097DA978B15

:100FE9000053F10623073F02A7A497C897DA978B06

:100FF9000053F10623073E381680621095042A949F

:1010090079030A94E74247E7434480391094790207

:101019000A94E76239E763368039109479010A94B2

:10102900E7822BE7832880391094E7A221E7A31EE2

:1010390097CF97DA978B005323072319DB97C7803C

:10104900641097C197C997D1979495792A4097C801

:1010590097DA978B0053F1062319DB95042A790057

:101069001497C197C997D19795792A09028710953D

:10107900450E80CA1102B01095450E80CA11CB6980

:10108900189505FC3F2C59309505FC80BB1002A032

:101099001095450E80CA119504067900071455313B

:1010A900C14C01C580CA11CB69183E0395A50595A8

:1010B900BBFC951506FE9505F89795AAFC9795AB87

:1010C900FD53380714229505E102DB1095450E8082

:1010D900CA1195E4E03514079505E102ED1095452F

:1010E9000E80CA1195E4E02314A09505E102FF10D2

:1010F90095450E80CA1195E4E01195A1B895B1B84E

:1011090014009505E102171195450E80CA1195E461

:10111900E0F914009505E102291195450E80CA11DF

:1011290095E4E0E714909505E1023B1195450E80A1

:10113900CA1195E4E0D595A1B895B1B8239505E113

:1011490002521195450E80CA11195E4E074950B1A67

:101159003D0297C3239505E1026A1195450E80CAA0

:101169001195E4E05C950B1A3D0297C3239505E1BF

:1011790002821195450E80CA1195E4E04495A1B803

:1011890095B1B8950B1A3D0297C3239505E102A0C5

:101199001195450E80CA1195E4E026950B1A3D027A

:1011A90097C3239505E102B81195450E80CA11959B

:1011B900E4E00E950B1A3D0297C3239505E1180974C

:1011C9001095E5E80380260F3A4095E0121B951526

:1011D90000E595A6E89504E43195B6E8C14C03808D

:1011E900931294EC1C2880260F950406947900F636

:1011F900950427947900D7951500E595A6E89504F7

:10120900E43195B6E894EC01DDC1D480260FD1D143

:10121900D18D0021947F0DD121947E07C101C1C117

:1012290080260FC1C29495E03A062F2E2E804109DF

:1012390095B3DB9504273C12C1212695053BC121B5

:10124900C1979495793B0A80CA11D1D1D1D1950B17

:10125900069515002795E2F4089504DD59CF8073AA

:10126900129504DD979569DF59CF95B2F495A2F6E9

:101279009505DD95150BDB95B7F795B0F7021714B2

:1012890095452E9515001580CA112AEF97C197E942

:10129900040397890097C99795792A2E97E9001928

:1012A90095A1B8710395B1B895A2F69515D8DD95B4

:1012B900B2F495150BDB80101395A2F69515D8DDC0

:1012C90095B2F495150BDB80101395A1B8710395B0

:0212D900B1B8AA

:1012DB00950402947900E095B0E895B3E895A0B831

:1012EB0014009515FFE59505E495A4E895B4E895EC

:1012FB00A0BA9504059505E195E4E0FC95B0BA9587

:10130B00A3E8802C1395A0BA9504059505E195E407

:10131B00E0FC95B0BA95A1E895B1E895A1E895B137

:10132B00E897C992279795692A3F02921997DA97FE

:10133B0092DB532D0723D995150127E9400C949582

:10134B00E0282295150027807013E9600795E128A6

:10135B00F2807013E9800795E228E880701395E31B

:10136B0028E18070139792C93D1B9556DC26632D9F

:10137B00075334072397D9979501009792D99795DF

:10138B00691195052997C99795792A1480970E9518

:10139B00A2F69515DBDD95B2F495150BDB80970E58

:1013AB00950402947900E880C70B3A4095B7F795FE

:1013BB00B0F795A2F69515CFDD95B2F495150BDB2D

:1013CB0002171495452E140031C131C13101C1141E

:1013DB005531C18C20D4D4D4D4D495150112951584

:1013EB000027950B069515001502B30F95450E3A80

:1013FB001095A0BA95040529EF9505E195E4E0FC5D

:10140B0095B0BA95A1E895B1E880260F2F2E2E3A0C

:10141B0040809312022D1795453080461402911689

:10142B0095453080461495150F2895150135955621

:10143B00213402AF149545308046142ABF2A7F957C

:10144B00043C3C0995E5BE092AEF80360195E5BEC3

:10145B00F795042B947900E3950B2B95042A94793B

:10146B00010995041979020C804614950419790128

:10147B000380461495042A3C25950429791D143FB5

:10148B000995A60595B70580A91495A60595A705F9

:10149B0080A914957B22263FF13EE695B6053A408E

:1014AB0095443083950428063F0C152CA402531544

:1014BB0095453080E214063F0C152DA402C01595FE

:1014CB00453080E214063E06157FA480E214152EEB

:1014DB00A402F91595453095920428922907927923

:1014EB00074292063E110442792F08951B363D07A1

:1014FB0095A02895150A3692063E1104627930089C

:10150B00951B373D0795A12895150A3792063E1175

:10151B000482793108951B383D0795A22895150A49

:10152B00388046149515FFE514559505E495A7E20B

:10153B0095B7E295A4E295B4E295A5E295B5E2954F

:10154B00A6E295B6E28046140442947920142697BD

:10155B0094794327151A4044405A6044505A780CE

:10156B00E21494792F1526979479430F157FA402D3

:10157B00AF1495453095B02880E214152CA4950432

:10158B0028063F21063F1E063F1B951E343D760263

:10159B00AF1495453095150135950421070707952F

:1015AB00053480FD0895150135950421070707952E

:1015BB00053480E21404629479211426979479639C

:1015CB0027151AA4046405A6046505A780E21494E4

:1015DB0079301526979479630F157FA402AF149574

:1015EB00453095B12880E214152DA480891504820D

:1015FB0094792214269794798327151AA4048405C9

:10160B00A6048505A780E214947931152697947961

:10161B00830F157FA402AF1495453095B22880E255

:10162B0014152EA480891581481795042A947901E5

:10163B001A048295053B297F94792C0C95043B2643

:10164B00979479830380810A804614947902170456

:10165B006295053B297F94792DEE95043B26979453

:10166B007963E580A70A94790317044295053B2912

:10167B007F94792ED395043B2697947943CA80CDDA

:10168B000A2AEF80360104A49479202A0482950556

:10169B003B297F94791A4F95043B2697947983467F

:1016AB0044849574203C0380DB0A152FA402321668

:1016BB0095453080461404A494792136046295052F

:1016CB003B297F94791A1F95043B269794796316CF

:1016DB0044649574203C0380FC0A1530A402321636

:1016EB00954530804614951B383DF895150A388082

:1016FB00FD0804A4947922EE044295053B297F94BE

:10170B00791AE395043B2697947943DA444495740C

:10171B00203C0380F1161531A4023216954530801A

:10172B0046148148173A4095E0280F95E1280B9510

:10173B00E2280795E3280380461480FA0904422621

:10174B00977943250441947F0404407E1C95E0283F

:10175B001F951B3D3D1A95150A3D95A02895042A0A

:10176B009479030C2AEF80360195150A3D95B02824

:10177B00046226977963250461947F0404607E1CC0

:10178B0095E1281F951B363D1A95150A3695A1280C

:10179B0095042A9479020C2AEF80360195150A36A6

:1017AB0095B128048226977983250481947F0404BC

:1017BB00807E1C95E2281F951B373D1A95150A371D

:1017CB0095A22895042A9479010C2AEF803601956D

:1017DB00150A3795B22804A2269779A31C04A19465

:1017EB007F0404A07E1395E32816951B383D1195B5

:1017FB00150A3895A328800B1895150A3895B32828

:01180B00825A

:00000001FF

We claim:

1. A time division multiplex wireless communication system, comprising:
(a) at least three communication transceivers;
(b) communication means for receiving information from a fixed number of other said communication transceivers;
(c) communication means for sending information to other said communication transceivers at a specified time relative to the last time information was sent or relative to the time a last piece of information was received from another said communication transceiver;
buffering means for storing said received information from said transmitting communication transceivers;
(d) addressing means for each said communication transceiver;
(e) address comparison means for determining if each said communication transceiver is part of a group that can communicate with other said communication transceivers; and
(f) whereby each said communication transceiver receives information only from a fixed number of other said communication transceivers whose said address is part of said group and whereby the received information is stored in said buffers that are assigned to each said communication transceiver.

2. The system of claim 1 further including means for said information received from multiple said communication transceivers to be summed to create a composite signal.

3. The system of claim 1 further including means for sending and receiving said information in a wireless manner at a substantially higher rate than said information is sent to its final destination or received from its origin.

4. A time division multiplex wireless communication system, comprising:
(a) at least three communication transceivers;
(b) communication means for receiving information from a fixed number of said communication transceivers;
(c) communication means for sending information to other said communication transceivers at a specified time relative to the last time information was sent or relative to the time a last piece of information was received from another said communication transceiver;
(d) buffering means for storing said received information from said transmitting communication transceivers;
(e) means for assigning a group number to each said communication transceiver;
(f) group number comparison means for determining if each said communication transceiver is part of the same group; and
(g) whereby each said communication transceiver receives information only from a fixed number of said communication transceivers whose said group number is the same and stores said received information in said buffers that are assigned to each said communication transceiver.

5. The system of claim 4 further including means for said information that is received from several said communication transceivers to be summed to create a composite signal.

6. The system of claim 4 further including means for sending and receiving said information in a wireless manner at a substantially higher rate than said information is sent to its final destination or received from its origin.

7. A method of providing a time division multiplex wireless communication system between several communication transceivers, comprising the steps of:
(a) transmitting a master command word from a master communication transceiver requesting another communication transceiver to join the communication link in a particular slave time slot;
(b) monitoring said wireless communication link with respect to whether a slave communication transceiver is sending a slave command word that is requesting to be added into said communication link in said slave time slot;
(c) generating a transmission in the master time slot as a master communication transceiver which includes a master command word and an address which tells said slave communication transceivers that want to add into said particular slave time slot which said slave communication transceiver will get said particular slave time slot;
(d) monitoring said wireless communication link with respect to whether said slave communication transceiver unit is transmitting an information packet with a changed command word in the appropriate time slot; and
(e) generating a transmission in said master time slot as said master communication transceiver which includes a new master command word that requests another communication transceiver to join said communication link in a different slave time slot if another slave time slot is available; or
(f) generating a transmission in said master time slot as said master communication transceiver which includes a master command word that does not request another communication transceiver to join said communication link.

8. The method of claim 7 further includes a method for said master communication transceiver to become a slave communication transceiver that searches for another master communication transceiver.

9. The method of claim 8 wherein the address of said master communication transceiver is used to determine the length of time said master communication transceiver searches for said slave communication transceivers before changing to said slave communication transceiver.

10. The method of claim 7 further includes a method for said master communication transceiver to allow other master communication transceivers to use time slots associated with said master communication transceiver whereby each master communication transceiver can assign said slave time slots.

11. The method of claim 10 further includes a method for said master communication transceiver to have said slave time slots associated only to it and no other master communication transceiver.

12. The method of claim 10 further includes a method for said master communication transceiver to communicate to other master communication transceivers.

13. The method of claim 7 further includes a method for said master communication transceiver to limit the number of slave communication transceivers filling said slave time slots to a number less than the total number of slave time slots.

14. The method of claim 7 further includes a method for said master communication transceiver to determine whether to allow said slave communication transceiver to use said slave time slot based on said address of said slave communication transceiver.

15. The method of claim 7 further includes a method for said master communication transceiver to determine whether to allow said slave communication transceiver to use said slave time slot based on the group number of said slave communication transceiver.

16. The method of claim 15 further includes a method for said group number of said communication transceiver to be changed to one of a set of different group numbers.

17. The method of claim 15 further includes a method for said group number of said communication transceiver to be changed to any group number.

18. The method of claim 14 further includes a method for said address of said communication transceiver to be changed to one of a set of different addresses.

19. The method of claim 14 further includes a method for said address of said communication transceiver to be changed to any address.

20. A method of providing a time division multiplex wireless communication system between several communication transceivers, comprising the steps of:
(a) monitoring the wireless communication link as a slave communication transceiver with respect to whether a master communication transceiver is sending a master command word requesting another communication transceiver to join said communication link in a particular slave time slot;
(b) generating a transmission in said slave time slot which includes an address and a slave command requesting to be added into said particular slave time slot;
(c) monitoring the master time slot in said communication link with respect to whether said master communication transceiver is sending a new master command word and said address which tells said slave communication transceiver to add into said particular slave time slot; and
(d) changing said slave command word and transmitting the new command in said slave time slot if said correct address was received from said master communication transceiver; or
(e) monitoring said wireless communication link with respect to whether said master communication transceiver is sending a different master command requesting another communication transceiver to join said communication link in a different slave time slot if said correct address was not received from said master communication transceiver.

21. The method of claim 20 further includes a method for said slave communication transceiver which becomes a master communication transceiver searching for slave communication transceivers.

22. The method of claim 21 wherein said address of said slave communication transceiver is used to determine the length of time said slave communication transceiver searches for said master communication transceiver before changing to said master communication transceiver.

23. The method of claim 20 further includes a method for said slave communication transceiver to receive other slave communication transceiver information during other slave time slots associated with said master communication transceiver.

24. The method of claim 20 further includes a method for said slave communication transceiver to communicate to other master communication transceivers.

25. The method of claim 23 further includes a method for said slave communication transceiver to receive information from said master and said slave communication transceivers but does not transmit information.

26. The method of claim 23 further includes a method for said slave communication transceiver not to receive said master and slave communication transceiver's information because of a master command sent by said master communication transceiver.

27. The method of claim 20 further includes a method for said slave communication transceiver to determine whether to transmit in said slave time slot based on said address of said master communication transceiver.

28. The method of claim 20 further includes a method for said slave communication transceiver to determine whether to transmit in said slave time slot based on a group number of said master communication transceiver contained in the master communication transceiver information packet.

29. The method of claim 28 further includes a method for said group number of said communication transceiver to be changed to one of a set of different group numbers.

30. The method of claim 28 further includes a method for said group number of said communication transceiver to be changed to any group number.

31. The method of claim 27 further includes a method for said address of said communication transceiver to be changed to one of a set of different addresses.

32. The method of claim 27 further includes a method for said address of said communication transceiver to be changed to any address.

33. A method of providing a time division multiplex wireless communication system between several communication transceivers, comprising the steps of:
(a) monitoring the wireless communication link as a slave communication transceiver with respect to whether a master communication transceiver is communicating on said communication link;
(b) joining said wireless communication link in a slave time slot that may be occupied by another slave communication transceiver; and
(c) receiving information from said master and other said slave communication transceivers but as said slave communication transceiver that does not transmit information.

34. The method of claim 33 further includes a method for said slave communication transceiver to not receive said master and slave communication transceiver's information because of a master command sent by said master communication transceiver.

35. The method of claim 33 further includes a method for said slave communication transceiver to transmit information to said master and other slave communication transceivers when a button is pushed.

36. The method of claim 33 further includes a method for said slave communication transceiver to transmit information to said master and other slave communication transceivers when a command is received allowing said slave communication transceiver to send information.

37. A method of providing a time division multiplex wireless communication system between several communication transceivers and receivers, comprising the steps of:
(a) monitoring the wireless communication link as a slave communication receiver with respect to whether a master communication transceiver is communicating on said communication link;
(b) joining said wireless communication link in a slave time slot that may be occupied by another slave communication transceiver; and
(c) receiving information from said master and other said slave communication transceivers but as said slave communication receiver.

38. A method of creating a time base in a time division multiplex wireless communication system as a master communication transceiver, comprising the steps of:
(a) providing a main timer to determine the next start time said master communication transceiver begins sending a new information packet;
(b) sending said new information packet at the end of said main timer; and
(c) resetting and starting said main timer relative to the start of said new packet.

39. The method of claim 38 further includes a method for said main timer to be further subdivided into sub-timers whose duration is about the time required for each slave communication transceiver to transmit an information packet.

40. The method of claim 39 further includes a method for each said sub-timer to be further subdivided into a start byte detect timer and a timer which determines when the next said start byte detect timer will start.

41. The method of claim 39 wherein each said sub-timer is started at the end of transmitting an information packet, at the end of receiving an information packet or at the time-out of the previous said sub-timer.

42. The method of claim 39 further includes a method for said sub-timers to be different lengths of time depending on whether said master communication transceiver is next to be received or said slave communication transceiver is next to be received.

43. A method of creating a time base in a time division multiplex wireless communication system as a slave communication transceiver, comprising the steps of:
(a) providing a main timer to determine the next start time that said slave communication transceiver will start sending a new information packet;
(b) sending said new information packet at the end of said main timer; and
(c) resetting and starting said main timer relative to the start of said new packet.

44. The method of claim 43 further includes a method for said main timer to be further subdivided into sub-timers whose duration is about the time required to transmit an information packet for each slave or master communication transceiver.

45. The method of claim 44 further includes a method for each said sub-timer to be further subdivided into a start byte detect timer and a timer which determines when the next said start byte detect timer will start.

46. The method of claim 44 wherein each sub-timer is started at the end of transmitting an information packet, at the end of receiving an information packet or at the time-out of the previous said sub-timer.

47. The method of claim 44 further includes a method for said sub-timers to be different lengths of time depending on whether said master communication transceiver is next to be received.

48. A method for allowing multiple different communication links using time division multiplex wireless communications to operate in the same wireless bandwidth by using different hopping patterns in a frequency hopping spread spectrum system for each said communication link.

49. A method for allowing multiple different communication links using time division multiplex wireless communications to operate in the same wireless bandwidth by using a delayed hopping pattern as compared to other groups of communication transceivers using the same hopping pattern in, a frequency hopping spread spectrum system.

50. A method for allowing multiple different communication links using time division multiplex wireless communications to operate in the same wireless bandwidth by using different spreading codes in a direct sequence spread spectrum system for each said communication link.

51. A method for allowing multiple different communication links using time division multiplex wireless communications to operate in the same wireless bandwidth by using a different time offset of the same spreading code in a direct sequence spread spectrum system for each said communication link.

52. A method of using the command word in an information packet which determines the use or meaning of the data in said information packet whereby different types of data are sent between more than two communication transceivers in a time division multiplex wireless communication system.

53. A method of accepting and using a received information packet in a time division multiplex wireless communication system between several communication transceivers, comprising the steps of:
(a) receiving said information packet from another communications transceiver; and
(b) accepting and using the rest of said information packet only if the start word is received with less than a majority of bit errors in said start word.

54. The method of claim 53 further includes a method for said data in said information packet to be accepted if the address in said information packet is correct even though an error detector detects an error.

55. The method of claim 53 further includes a method for said data in said information packet to be accepted if the group number in said information packet is correct even though an error detector detects an error.

56. The method of claim 53 further includes a method where said data not accepted in said information packet is converted to such a form as to create a signal when decoded that cannot be heard or can be filtered in such a way as to make said signal difficult to be heard in voice applications.

57. The method of claim 54 wherein said error detector is a checksum of the command word.

58. The method of claim 55 wherein said error detector is a checksum of the command word.

59. The method of claim 54 wherein said error detector only indicates errors if bit errors can not be corrected using error correction techniques.

60. The method of claim 55 wherein said error detector only indicates errors if bit errors can not be corrected using error correction techniques.

61. The method of claim 53 wherein said information packet is rejected only if an error detector and the group number or address is bad.

62. A method of counting bad information packets for determining when a communications transceiver has turn off or gone out of range in a time division multiplex wireless communication system between several communication transceivers, comprising the steps of:
(a) initializing bad reception counters for each time slot;
(b) changing said bad reception counter for said time slot by a count of one if a start word has too many bit errors to accept said information packet for said time slot;
(c) changing said bad reception counter for said time slot by a count of one if an error detector indicates errors in said received information packet for said time slot;
(d) reinitialize said bad reception counter for said time slot if said error detector indicates no errors in said information packet for said time slot;
(e) opening said slave time slot for another slave communications transceiver if said bad reception counter for said slave communication transceiver reaches a terminal count; and
(f) searching for a new master communication transceiver if said bad reception counter for the master communication transceiver time slot reaches a terminal count.

63. The method of claim 62 wherein said bad reception counter for said time slot is reinitialized if the address in said information packet is correct even though said error detector indicates errors in said received information packet.

64. The method of claim 62 wherein said bad reception counter for said time slot is reinitialized if the group number in said information packet is correct even though said error detector indicates errors in said received information packet.

65. The method of claim 62 wherein said error detector is a checksum to the command word.

66. The method of claim 62 wherein said error detector only indicates errors if said bit errors can not be corrected using error correction techniques.

67. The method of claim 62 wherein said error detector only indicates errors in the address and/or command information in said received information packet.
